(19) United States
(12) Patent Application Publication
(10) Pub. No.: US 2020/0164319 A1
(43) Pub. Date: May 28, 2020

(54) COMPOSITE MEMBRANES WITH IMPROVED PERFORMANCE AND/OR DURABILITY AND METHODS OF USE

(71) Applicant: 3M INNOVATIVE PROPERTIES COMPANY, St. Paul, MN (US)

(72) Inventors: Jinsheng Zhou, Woodbury, MN (US); Ryan C. Shirk, Mendota Heights, MN (US); David Scott Seitz, Woodbury, MN (US); Moses M. David, Wells, TX (US)

(21) Appl. No.: 16/638,167

(22) PCT Filed: Aug. 14, 2018
(86) PCT No.: PCT/IB2018/056105

§ 371 Date: Feb. 11, 2020

Related U.S. Application Data
(60) Provisional application No. 62/546,152, filed on Aug. 16, 2017.

(51) Int. Cl. B01D 69/12; B01D 69/10; B01D 61/36

(52) U.S. Cl. CPC B01D 69/12; B01D 69/10; B01D 61/362; B01D 2325/022; B01D 2323/30; B01D 2323/345

(57) ABSTRACT

A composite membrane for selectively separating (e.g., pervaporating) a first fluid (e.g., first liquid such as a high octane compound) from a mixture comprising the first fluid (e.g., first liquid such as a high octane compound) and a second fluid (e.g., second liquid such as gasoline). The composite membrane includes a porous substrate comprising opposite first and second major surfaces, and a plurality of pores. A pore-filling polymer is disposed in at least some of the pores so as to form a layer having a thickness within the porous substrate. The composite membrane further includes at least one of: (a) an ionic liquid mixed with the pore-filling polymer; or (b) an amorphous fluorochemical film disposed on the composite membrane.

### BACKGROUND

Separation membranes are known; however, there is a continual need for effective composite membranes.

### SUMMARY OF THE INVENTION

The present disclosure provides composite membranes and methods of use of such membranes in separation techniques. Generally, the composite membranes include a porous substrate (i.e., a support substrate that may include one or more layers) that includes opposite first and second major surfaces, and a plurality of pores; and a pore-filling polymer disposed in at least some of the plurality of pores so as to form a layer having a thickness within the porous substrate. Composite membranes of the present disclosure further include at least one of: (a) an ionic liquid (i.e., a liquid ionic compound) mixed with the pore-filling polymer; or (b) an amorphous fluorochemical film disposed on the composite membrane.

In certain embodiments the layer is a continuous layer. For composite membranes that are asymmetric, the amount of the polymer at, or adjacent to, the first major surface is greater than the amount of the polymer at, or adjacent to, the second major surface.

Such membranes are particularly useful for selectively pervaporating a first liquid from a mixture that includes the first liquid and a second liquid, generally because the pore-filling polymer is more permeable to the first liquid (e.g., alcohols, particularly higher octane alcohols, sulfur-containing compounds, aromatics, and other high octane compounds) than the second liquid (e.g., gasoline and other such fuels). Furthermore, in certain embodiments, the pore-filling polymer is not soluble in at least a mixture of the first liquid and the second liquid, and preferably, in the first liquid and the second liquid.

The second liquid (e.g., gasoline) could naturally include the first liquid (e.g., high octane compounds or sulfur-containing compounds), or the first liquid (e.g., alcohols or high octane compounds) could be added to the second liquid (e.g., gasoline).

In one embodiment, the present disclosure provides an asymmetric composite membrane for selectively pervaporating a first liquid (e.g., alcohols, particularly higher octane alcohols, sulfur-containing compounds, aromatics, and other high octane compounds) from mixture that includes the first liquid (e.g., an alcohol) and a second liquid (e.g., gasoline and other such fuels). The asymmetric composite membrane includes: a porous substrate having opposite first and second major surfaces, and a plurality of pores; and a pore-filling polymer disposed in at least some of the pores so as to form a layer having a thickness within the porous substrate, with the amount of the polymer at, or adjacent to, the first major surface being greater than the amount of the polymer at, or adjacent to, the second major surface, wherein the polymer is more permeable to the first liquid (e.g., alcohol) than the second liquid (e.g., gasoline) (and, in certain embodiments, not soluble in the first liquid (e.g., alcohol), the second liquid (e.g., gasoline), or a combination thereof). Such asymmetric composite membrane further includes at least one of: (a) an ionic liquid (i.e., a liquid ionic compound) mixed with the pore-filling polymer; or (b) an amorphous fluorochemical film disposed on the composite membrane.

Such membranes may be included in a cartridge, which may be part of a system such as a flex-fuel engine.

The present disclosure also provides methods. For example, the present disclosure provides a method of separating a first liquid (e.g., ethanol, other higher octane alcohols, sulfur-containing compounds, aromatics, and other high octane compounds) from a mixture of the first liquid (e.g., ethanol, other higher octane alcohols, sulfur-containing compounds, aromatics, and other high octane compounds) and a second liquid (e.g., gasoline and other such fuels), the method comprising contacting the mixture with a composite membrane (preferably, an asymmetric composite membrane) as described herein.

Herein, “gasoline” refers to refined petroleum used as fuel for internal combustion engines.

Herein, a “high octane” compound is one that has an octane level (i.e., octane rating or octane number), which is a standard measure of the performance of gasoline, of at least 87 on the AKI (anti-knock index), which is the average of the RON (research octane number) and MON (motor octane number) indices. The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numerical values are assumed to be modified by the term “about” and in certain situations, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 20° C. to 25° C. or 22° C. to 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1 is a cross-sectional schematic view of an exemplary porous substrate 10 and an asymmetric composite membrane 30 of the present disclosure.

FIG. 2 is a perspective side view of a module that includes an exemplary composite membrane of the present disclosure.

FIG. 3 is an illustration of an exemplary fuel separation system that includes an exemplary composite membrane of the present disclosure.

FIG. 4 is an illustration of a vacuum pervaporation testing apparatus.

FIG. 5 is a graph of the GC response area vs ethanol concentration (y=45948x; R²=0.9988).

FIG. 6 is an SEM photograph (3000×) of the small pore side of the porous substrate used to make the composite membrane in Example 1.

FIG. 7 is an SEM photograph (3000×) of the large pore side of the porous substrate used to make the composite membrane in Example 1.

FIG. 8 is an SEM photograph (3000×) of the irradiated pore-filled side of the composite membrane according to Example 1.

FIG. 9 is an SEM photograph (3000×) of the non-irradiated side of the composite membrane according to Example 1.

FIG. 10 is a TEM image of a cross-section of the porous substrate according to Example 6.

FIG. 11 is a TEM image of a cross-section of the asymmetric composite membrane according to Example 6.

FIG. 12 shows a cross-sectional image of an asymmetric composite membrane of the present disclosure prepared according to Example 23.

### DETAILED DESCRIPTION OF ILLUSTRATIVE EMBODIMENTS

The present disclosure provides composite membranes (preferably, asymmetric composite membranes) that include a porous substrate and a pore-filling polymer. The porous substrate has opposite first and second major surfaces, and a plurality of pores. The pore-filling polymer is disposed in at least some of the pores.

Composite membranes of the present disclosure further include at least one of: (a) an ionic liquid (i.e., a liquid ionic compound) mixed with the pore-filling polymer; or (b) an amorphous fluorochemical film disposed on the composite membrane, typically, on the side of the membrane the feed mixture enters. Such composite membranes demonstrate improved performance (e.g., flux) and/or durability over the same composite membranes without either the liquid ionic compound or the amorphous fluorochemical film.

In certain embodiments in which the composite membranes are asymmetric composite membranes the amount of the pore-filling polymer at, or adjacent to, the first major surface is greater than the amount of the pore-filling polymer at, or adjacent to, the second major surface. Hence, a composite membrane is asymmetric with respect to the amount of pore-filling polymer throughout the thickness of the porous substrate.

Such composite membranes may be used in various separation methods, including pervaporation, gas separation, vapor permeation, nanofiltration, organic solvent nanofiltration, and combinations thereof (e.g., a combination of pervaporation and vapor permeation).

Such separation methods may be used to separate a first fluid (i.e., liquid and/or vapor) from a feed mixture of a first fluid (i.e., liquid and/or vapor) and a second fluid (i.e., liquid and/or vapor). The first fluid may be a natural or inherent component of the second fluid, or the first fluid could be an additive in the second fluid. Either type of mixture may be a “feed mixture” as used herein.

The preferred separation membranes of the present disclosure are particularly useful in pervaporation methods to separate a first fluid (e.g., a first liquid) from a feed mixture of a first fluid (e.g., first liquid) and a second fluid (e.g., second liquid).

Pervaporation is a process that involves a membrane in contact with a liquid on the feed or upstream side and a vapor on the “permeate” or downstream side. Usually, a vacuum and/or an inert gas is applied on the vapor side of the membrane to provide a driving force for the process. Typically, the downstream pressure is lower than the saturation pressure of the permeate.

Vapor permeation is quite similar to pervaporation, except that a vapor is contacted on the feed side of the membrane instead of a liquid. As membranes suitable for pervaporation separations are typically also suitable for vapor permeation separations, use of the term “pervaporation” may encompass both “pervaporation” and “vapor permeation.”

Pervaporation may be used for desulfurization of gasoline, dehydration of organic solvents, isolation of aroma compounds or components (i.e., odorants), and removal of volatile organic compounds from aqueous solutions. Pervaporation may be used also for separating and concentrating high octane compounds from a fuel mixture for use in “octane-on-demand” internal combustion engines. In certain embodiments of the present disclosure, the asymmetric composite membranes are used for pervaporating high octane compounds (e.g., alcohol and/or aromatics) from a mixture of gasoline and alcohol and/or aromatics. In certain embodiments of the present disclosure, the asymmetric composite membranes are used for pervaporating alcohol from an alcohol and gasoline mixture.

There is a need for highly selective membranes. Traditional composite membranes include a selective thin polymer coating supported on an underlying porous support. Such selective layers will absorb one or more components in a mixture to be separated, which causes their swelling. The swelling will not only decrease mechanical strength but also affect membrane performance. Introduction of chemical crosslinking density or impermeable physical regions could restrain the material swelling to some extent, but this may reduce the permeability. Thus, there is a challenge to create a membrane with effective pervaporation performance and mechanical strength. Also, it is challenging to apply a very thin coating without causing defects or pinholes. One or more composite membranes of the present disclosure have solved one or more of these problems and provide an appropriate balance of properties.

Generally, the composite membranes of the present disclosure include a porous substrate (i.e., a support substrate which may be in the form of one or more porous layers) that includes opposite first and second major surfaces, and a plurality of pores; and a pore-filling polymer disposed in at least some of the plurality of pores so as to form a layer having a thickness within the porous substrate. In certain embodiments, the pore-filling polymer layer is preferably a continuous layer. The amount of the polymer at, or adjacent to, the first major surface is greater than the amount of the polymer at, or adjacent to, the second major surface in an asymmetric composite membrane.

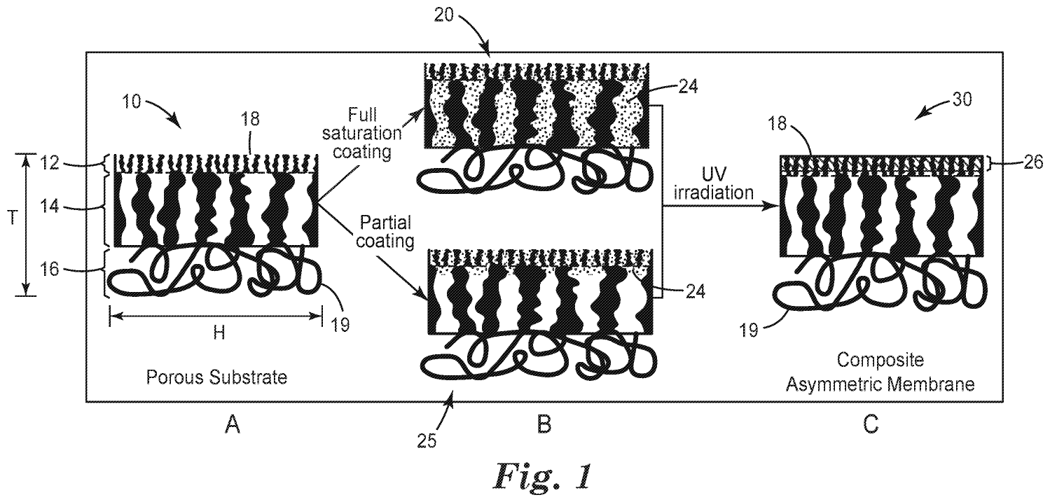

Referring to FIG. 1, illustrations of an exemplary porous substrate 10 (FIG. 1A) and an exemplary asymmetric composite membrane 30 (FIG. 1C), with intermediates 20 and 25 (FIG. 1B), are shown in vertical cross-section. The exemplary porous substrate 10 includes three layers that include a nanopororous layer 12, a microporous layer 14, and a macroporous layer 16 (FIG. 1A) having a first major surface 18 and a second major surface 19. During processing, various intermediates could be formed. Two examples of intermediates are shown as 20 and 25 in FIG. 1B. The porous substrate 10 may be fully saturated with a curable pore-filling polymer composition 24 to create intermediate 20 (top panel of FIG. 1B), or the porous substrate 10 may be only partially filled with a curable pore-filling polymer composition 24 to create intermediate 25 (bottom panel of FIG. 1B). That is, the curable pore-filling polymer composition 24 may be disposed in at least some of the plurality of pores. Once the curable (i.e., polymerizable and/or crosslinkable) pore-filling polymer composition 24 is exposed to a radiation source, such as an ultraviolet radiation source, and cured (i.e., polymerized and/or crosslinked), and the uncured pore-filling polymer composition washed away (if there is any), a pore-filling polymer layer 26 is formed. That is, whether the porous substrate is initially fully saturated with (as in intermediate 20), or only partially filled with (as in intermediate 25), the pore-filling polymer, upon being cured and the uncured portion washed away, forms a polymer layer 26. In certain embodiments, this polymer layer 26 has a thickness and is formed within the porous substrate 10, such that the amount of the polymer at, or adjacent to, the first major surface 18 is greater than the amount of the polymer at, or adjacent to, the second major surface 19, thereby forming an exemplary asymmetric composite membrane 30 of the present disclosure (FIG. 1C).

In a porous substrate 10, the pores are interconnected vertically (i.e., throughout the thickness “T” of the porous substrate 10, see FIG. 1A). In certain preferred embodiments, the pores of the porous substrate 10 are interconnected horizontally (e.g., as in a microfiltration membrane) along dimension “H” (see FIG. 1A). In such embodiments, the pore-filling polymer layer 26 (FIG. 1C) formed by the pore-filling polymer 24 is preferably a continuous layer. If the pores of the porous substrate 10 are not all interconnected horizontally (along dimension “H”), the layer 26 is discontinuous (i.e., the pore-filling polymer forms a plurality of discreet regions within the porous substrate). It will be understood that dimension “H” generally refers to the plane of the porous substrate and is exemplary of all the various horizontal dimensions within a horizontal slice of the substrate (shown in vertical cross-section). Whether layer 26 is continuous or discontinuous, for the asymmetric composite membrane, the amount of the pore-filling polymer at, or adjacent to, the first major surface 18 is greater than the amount of the polymer at, or adjacent to, the second major surface 19.

As a specific example, reference is to FIG. 12, which shows a cross-sectional image of an asymmetric composite membrane 240 of the present disclosure prepared according to Example 23. In this embodiment, the asymmetric composite membrane 240 includes one layer of a nanoporous substrate 242. The pore-filling polymer is shown in a continuous layer 244.

As used herein, a continuous layer refers to a substantially continuous layer as well as a layer that is completely continuous. A substantially continuous layer is a layer that is continuous enough that the asymmetric composite membrane is able to selectively pervaporate a desired amount of the first liquid (e.g., alcohol, or other high octane compounds such as aromatics) from a mixture of the first liquid with a second liquid (e.g., gasoline or other such fuels). In particular, the flux and the selectivity of the composite membrane (with a “continuous layer” of pore-filling polymer) is sufficient for the particular system in which the membrane is used.

Such membranes are particularly useful for selectively pervaporating a first fluid (e.g., a first liquid such as high octane compounds) from a mixture that includes the first fluid (e.g., a first liquid such as high octane compounds) and a second fluid (e.g., a second liquid such as gasoline or other such fuels), generally because the pore-filling polymer is more permeable to the first fluid (e.g., first liquid) than the second fluid (e.g., second liquid). Furthermore, in certain embodiments, the pore-filing polymer is not soluble in the first liquid, the second liquid, or a combination thereof.

In certain embodiments, the first liquid is a more polar liquid than the second liquid. The second liquid may be a nonpolar liquid.

In certain embodiments, the first liquid may be water, an alcohol (such as ethanol, methanol, 1-propanol, 2-propanol, 1-methoxy-2-propanol, or butanol), or an organic sulfur-containing compound (such as thiophene, tetrahydrothiophene, benzothiophene, 2-methylthiophene, or 2,5-dimethylthiophene). In certain embodiments, the first liquid may be high octane compounds, such as an alcohol, or aromatic hydrocarbons (i.e., aromatics) such as toluene and xylene.

Some compounds may be removed because they are undesirable (e.g., sulfur-containing compounds in fuel such as gasoline). Some compounds may be removed because they are desirable to form a separate concentrate for later use (e.g., high octane compounds such as aromatics). Thus, in certain embodiments, the first liquid may be a high octane compound, i.e., one having an octane rating of at least 87 (AKI) (e.g., ethanol and aromatics).

In certain embodiments, the second liquid may be gasoline or other such fuel. In certain embodiments, the first liquid is an alcohol, and the second liquid is gasoline. Thus, in one embodiment of the present disclosure, an asymmetric composite membrane for selectively pervaporating alcohol from an alcohol and gasoline feed mixture is provided. This asymmetric composite membrane includes: a porous substrate having opposite first and second major surfaces, and a plurality of pores; and a pore-filling polymer disposed in at least some of the pores so as to form a continuous layer having a thickness, with the amount of the polymer at, or adjacent to, the first major surface being greater than the amount of the pore-filling polymer at, or adjacent to, the second major surface, wherein the polymer is more permeable to alcohol than gasoline.

In certain embodiments, the first liquid is an organic compound having an octane rating of at least 87, and the second liquid is a fuel (e.g., gasoline). Thus, in one embodiment of the present disclosure, an asymmetric composite membrane for selectively pervaporating a high octane compound from a fuel feed mixture that includes such high octane compounds is provided. This method results in separating and concentrating high octane compounds. This asymmetric composite membrane includes: a porous substrate having opposite first and second major surfaces, and a plurality of pores; and a pore-filling polymer disposed in at least some of the pores so as to form a continuous layer having a thickness, with the amount of the polymer at, or adjacent to, the first major surface being greater than the amount of the pore-filling polymer at, or adjacent to, the second major surface, wherein the polymer is more permeable to the high octane compounds than the other components (e.g., low octane compounds) in the fuel.

Low octane compounds, i.e., those having an octane rating of less than 87 (AKI) include, for example, n-hexane, n-pentane, n-octane, n-nonane, n-dexane. High octane compounds, i.e., those having an octane rating of at least 87 (AKI) include, for example, methanol, ethanol, iso-butanol, as well as xylene, toluene, and other aromatics.

### Porous Substrate

The porous substrate itself may be asymmetric or symmetric. The porous substrate may include one layer or multiple layers. For example, there may be two, three, four, or more layers. In some embodiments, the porous substrate is hydrophobic. In other embodiments, the porous substrate is hydrophilic.

If the porous substrate is asymmetric (before being combined with the pore-filling polymer), the first and second major surfaces have porous structures with different pore morphologies. For example, the porous substrate may have pores of differing sizes throughout its thickness. Analogously, if the porous substrate is symmetric (before being combined with the pore-filling polymer), the major surfaces have porous structures wherein their pore morphologies are the same. For example, the porous substrate may have pores of the same size throughout its thickness.

Referring to FIG. 1A, an asymmetric substrate is shown with different pore morphologies at the first major surface 18 and the second major surface 19. More specifically, there are three layers each of different pore size such that the overall substrate has pores of differing sizes throughout its thickness “T.” In certain embodiments, nanoporous layer 12 alone could function as the porous substrate. In such embodiments, the porous substrate would be symmetric.

Suitable porous substrates include, for example, films, porous membranes, woven webs, nonwoven webs, hollow fibers, and the like. For example, the porous substrates may be made of one or more layers that include films, porous films, micro-filtration membranes, ultrafiltration membranes, nanofiltration membranes, woven materials, and nonwoven materials. The materials that may be used for each of the above-mentioned supports may be organic in nature (such as the organic polymers listed below), inorganic in nature (such as aluminum, steels, and sintered metals and/or ceramics and glasses), or a combination thereof. For example, the porous substrate may be formed from polymeric materials, ceramic and glass materials, metal, and the like, or combinations (i.e., mixtures and copolymers) thereof.

In composite membranes of the present disclosure, materials that withstand hot gasoline environment and provide sufficient mechanical strength to the composite membranes are preferred. Materials having good adhesion to each other are particularly desirable. In certain embodiments, the porous substrate is preferably a polymeric porous substrate.

Suitable polymeric materials include, for example, polystyrene, polyolefins, polyisoprenes, polybutadienes, fluorinated polymers (e.g., polyvinylidene fluoride (PVDF), ethylene-co-chlorotrifluoroethylene copolymer (ECTFE), polytetrafluoroethylene (PTFE)), polyvinyl chlorides, polyesters (PET), polyamides (e.g., various nylons), polyimides, polyethers, poly(ether sulfone)s, poly(sulfone)s, poly(phenylene sulfone)s, polyphenylene oxides, polyphenylene sulfides (PPS), poly(vinyl acetate)s, copolymers of vinyl acetate, poly(phosphazene)s, poly(vinyl ester)s, poly(vinyl ether)s, poly(vinyl alcohol)s, polycarbonates, polyacrylonitrile, polyethylene terephthalate, cellulose and its derivatives (such as cellulose acetate and cellulose nitrate), and the like, or combinations (i.e., mixtures or copolymers) thereof.

Suitable polyolefins include, for example, poly(ethylene), poly(propylene), poly(l-butene), copolymers of ethylene and propylene, alpha olefin copolymers (such as copolymers of 1-butene, 1-hexene, 1-octene, and 1-decene), poly(ethylene-co-1-butene), poly(ethylene-co-1-butene-co-1-hexene), and the like, or combinations (i.e., mixtures or copolymers) thereof.

Suitable fluorinated polymers include, for example, polyvinylidene fluoride (PVDF), polyvinyl fluoride, copolymers of vinylidene fluoride (such as poly(vinylidene fluoride-co-hexafluoropropylene)), copolymers of chlorotrifluoroethylene (such as ethylene-co-chlorotrifluoroethylene copolymer), polytetrafluoroethylene, and the like, or combinations (i.e., mixtures or copolymers) thereof.

Suitable polyamides include, for example, poly(imino(1-oxohexamethylene)), poly(iminoadipoylimino hexamethylene), poly(iminoadipoyliminodecamethylene), polycaprolactam, and the like, or combinations thereof.

Suitable polyimides include, for example, poly(pyromellitimide), polyetherimide and the like.

Suitable poly(ether sulfone)s include, for example, poly(diphenylether sulfone), poly(diphenylsulfone-co-diphenylene oxide sulfone), and the like, or combinations thereof.

Suitable polyethers include, for example, polyetherether ketone (PEEK).

Such materials may be photosensitive or non-photosensitive. Photosensitive porous substrate materials may act as a photoinitiator and generate radicals which initiate polymerization under radiation sources, such as UV radiation, so that the filled polymer could covalently bond to the porous substrate. Suitable photosensitive materials include, for example, polysulfone, polyethersulfone, polyphenylenesulfone, PEEK, polyimide, PPS, PET, and polycarbonate. Photosensitive materials are preferably used for nanoporous layers.

Suitable porous substrates may have pores of a wide variety of sizes. For example, suitable porous substrates may include nanoporous membranes, microporous membranes, microporous nonwoven/woven webs, microporous woven webs, microporous fibers, nanofiber webs and the like. In some embodiments, the porous substrate may have a combination of different pore sizes (e.g., micropores, nanopores, and the like). In one embodiment, the porous substrate is microporous.

In some embodiments, the porous substrate includes pores that may have an average pore size less than 10 micrometers (μm). In other embodiments, the average pore size of the porous substrate may be less than 5 μm, or less than 2 μm, or less than 1 μm.

In other embodiments, the average pore size of the porous substrate may be greater than 10 nm (nanometer). In some embodiments, the average pore size of the porous substrate is greater than 50 nm, or greater than 100 nm, or greater than 200 nm.

In certain embodiments, the porous substrate includes pores having an average size in the range of from 0.5 nm up to and including 1000 μm. In some embodiments, the porous substrate may have an average pore size in a range of 10 nm to 10 μm, or in a range of 50 nm to 5 μm, or in a range of 100 nm to 2 μm, or in a range of 200 nm to 1 μm.

In certain embodiments, the porous substrate includes a nanoporous layer. In certain embodiments, the nanoporous layer is adjacent to or defines the first major surface of the porous substrate. In certain embodiments, the nanoporous layer includes pores having a size in the range of from 0.5 nanometer (nm) up to and including 100 nm. In accordance with the present disclosure, the size of the pores in the nanoporous layer may include, in increments of 1 nm, any range between 0.5 nm and 100 nm. For example, the size of the pores in the nanoporous layer may be in the range of from 0.5 nm to 50 nm, or 1 nm to 25 nm, or 2 nm to 10 nm, etc. Molecular Weight Cut-Off (MWCO) is typically used to correlate to the pore size. That is, for nanopores, the molecular weight of a polymer standard (retain over 90%) such as dextran, polyethylene glycol, polyvinyl alcohol, proteins, polystyrene, poly(methyl methacrylate) may be used to characterize the pore size. For example, one supplier of the porous substrates evaluates the pore sizes using a standard test, such as ASTM E1343-90-2001 using polyvinyl alcohol.

In certain embodiments, the porous substrate includes a microporous layer. In certain embodiments, the microporous layer is adjacent to or defines the first major surface of the porous substrate. In certain embodiments, the microporous layer includes pores having a size in the range of from 0.01 μm up to and including 20 μm. In accordance with the present disclosure, the size of the pores in the microporous layer may include, in increments of 0.05 μm, any range between 0.01 μm up and 20 μm. For example, the size of the pores in the microporous layer may be in the range of from 0.05 μm to 10 μm, or 0.1 μm to 5 μm, or 0.2 μm to 1 μm, etc. Typically, the pores in the microporous layer may be measured by mercury porosimetry for average or largest pore size, bubble point pore size measurement for the largest pores, Scanning Electron Microscopy (SEM) and/or Atom Force Microscopy (AFM) for the average/largest pore size.

In certain embodiments, the porous substrate includes a macroporous layer. In certain embodiments, the macroporous layer is adjacent to or defines the first major surface of the porous substrate. In certain embodiments, the macroporous layer is embedded between two microporous layers, for example a BLA020 membrane obtained from 3M Purification Inc.

In certain embodiments, the macroporous layer comprises pores having a size in the range of from 1 μm and 1000 μm. In accordance with the present disclosure, the size of the pores in the macroporous layer may include, in increments of 1 μm, any range between 1 μm up to and including 1000 μm. For example, the size of the pores in the macroporous substrate may be in the range of from 1 μm to 500 μm, or 5 μm to 300 μm, or 10 μm to 100 μm, etc. Typically, the size of the pores in the macroporous layer may be measured by Scanning Electron Microscopy, or Optical Microscopy, or using a Pore Size Meter for Nonwovens.

The macroporous layer is typically preferred at least because the macropores not only provide less vapor transport resistance, compared to microporous or nanoporous structures, but the macroporous layer can also provide additional rigidity and mechanical strength.

The thickness of the porous substrate selected may depend on the intended application of the membrane. Generally, the thickness of the porous substrate (“T” in FIG. 1A) may be greater than 10 micrometers (μm). In some embodiments, the thickness of the porous substrate may be greater than 1,000 μm, or greater than 5,000 μm. The maximum thickness depends on the intended use, but may often be less than or equal to 10,000 μm.

In certain embodiments, the porous substrate has first and second opposite major surfaces, and a thickness measured from one to the other of the opposite major surfaces in the range of from 5 μm up to and including 500 μm. In accordance with the present disclosure, the thickness of the porous substrate may include, in increments of 25 μm, any range between 5 μm and 500 μm. For example, the thickness of the porous substrate may be in the range of from 50 μm to 400 μm, or 100 μm to 300 μm, or 150 μm to 250 μm, etc.

In certain embodiments, the nanoporous layer has a thickness in the range of from 0.01 μm up to and including 10 μm. In accordance with the present disclosure, the thickness of the nanoporous layer may include, in increments of 50 nm, any range between 0.01 μm and 10 μm. For example, the thickness of the nanoporous layer may be in the range of from 50 nm to 5000 nm, or 100 nm to 3000 nm, or 500 nm to 2000 nm, etc.

In certain embodiments, the microporous layer has a thickness in the range of from 5 μm up to and including 300 μm. In accordance with the present disclosure, the thickness of the microporous layer may include, in increments of 5 μm, any range between 5 μm and 300 μm. For example, the thickness of the microporous layer may be in the range of from 5 μm to 200 μm, or 10 μm to 200 μm, or 20 μm to 100 μm, etc.

In certain embodiments, the macroporous layer has a thickness in the range of from 25 μm up to and including 500 μm. In accordance with the present disclosure, the thickness of the macroporous layer may include, in increments of 25 μm, any range between 25 μm up and 500 μm. For example, the thickness of the macroporous substrate may be in the range of from 25 μm to 300 μm, or 25 μm to 200 μm, or 50 μm to 150 μm, etc.

In certain embodiments, there may be anywhere from one to four layers in any combination within a porous substrate. The individual thickness of each layer may range from 5 nm to 1500 μm in thickness.

In certain embodiments, each layer may have a porosity that ranges from 0.5% up to and including 95%.

### Pore-Filling Polymer

In general, the pore-filling polymer is insoluble in the liquids in which it comes into contact during use. More specifically, the pore-filling polymer is more permeable to a first liquid than a second liquid. In certain embodiments, the pore-filling polymer is not soluble in at least a mixture of the first and second liquids, and preferably, the first liquid and the second liquid. As used herein, the polymer is considered to be insoluble (or not soluble) in the first liquid (particularly, alcohol or other high octane compounds such as aromatics), the second liquid (particularly, gasoline or other such fuels), or a mixture thereof, even if insignificant amounts of the polymer are soluble in the liquids. In the context of the end use, the solubility of the pore-filling polymer is insignificant if the utility and lifetime of the composite membranes are not adversely affected. Preferably, “insoluble” and “not soluble” mean there can be a small amount of solubility, the membrane survives conditions of use for at least 30 hours, or at least 40 hours, or at least 50 hours, or at least 60 hours, or at least 70 hours, or at least 80 hours, or at least 90 hours, or at least 100 hours, or at least 110 hours, or at least 120 hours, or at least 125 hours, of use during a separation process.

In certain embodiments, the pore-filling polymer is in the form of a pore-filling polymer layer 26 (FIG. 1C) that forms at least a portion of the first major surface 18 of the porous substrate. In certain embodiments, the pore-filling polymer is in the form of a pore-filling polymer layer having an exposed major surface, which coats the first major surface of the porous substrate, and an opposite major surface disposed between the opposite first and second major surfaces of the porous substrate. In certain embodiments, the exposed major surface of the pore-filling polymer layer coats all the first major surface of the porous substrate.

In certain embodiments, the pore-filling polymer forms a coating on (i.e., covers) the top surface of the substrate in addition to being within the pores of the substrate. This coating layer may be 1 micrometer thick. This top coating layer may be continuous or discontinuous.

That is, as used herein, any reference to the pore-filling polymer layer coating or covering the first major surface of the porous substrate includes the pore-filling polymer layer coating all, substantially all, or only a portion of the first major surface of the porous substrate. The pore-filling polymer layer is considered to coat substantially all of the first major surface of the porous substrate (i.e., be substantially continuous), when enough of the first major surface of the porous substrate is coated such that the composite membrane is able to selectively pervaporate a desired amount of a first liquid (e.g., alcohol or other high octane compounds such as aromatics) from a mixture of the first liquid with a second liquid (e.g., gasoline or other such fuels).

In certain embodiments, the pore-filling polymer layer has a thickness in the range of from 10 nm up to and including 20,000 nm. More specifically, the thickness of the pore-filling polymer layer may include, in increments of 1 nm, any range between 10 nm and 20,000 nm. For example, the thickness of the pore-filling polymer layer may be in the range of from 11 nm to 5999 nm, or 20 nm to 6000 nm, or 50 nm to 5000 nm, etc.

The pore-filling polymer may be crosslinked. The crosslinking may be physical crosslinking and/or chemical crosslinking such as, e.g., in the form of an interpenetrating network (IPN). It may be grafted to the porous (substrate) membrane (e.g., which may be in the form of a nanoporous layer). Or, it may be crosslinked and grafted to the porous substrate (e.g., nanoporous layer).

In certain embodiments, the pore-filling polymer may swell in the presence of alcohol (e.g., ethanol) and/or other high octane compounds (e.g., aromatic compounds) but not gasoline and/or other such fuels. When the pore-filling polymer swells in the presence of the alcohol or other high octane compound, the resultant swollen polymer may be referred to as a gel.

In certain embodiments, the starting materials for the pore-filling polymer include polymerizable materials such as ethylenically unsaturated monomers and/or oligomers.

In certain embodiments, the starting materials for the pore-filling polymer include (meth)acrylate-containing monomers and/or oligomers. Suitable (meth)acrylate-containing monomers and/or oligomers may be selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, a urethane diacrylate, a urethane hexa-acrylate, a urethane triacrylate, a polymeric tetrafunctional acrylate, a polyester penta-acrylate, an epoxy diacrylate, a polyester triacrylate, a polyester tetra-acrylate, an amine-modified polyester triacrylate, an alkoxylated aliphatic diacrylate, an ethoxylated bisphenol di(meth)acrylate, a propoxylated triacrylate, and 2-acrylamido-2-methylpropanesulfonic acid (AMPS). Various combinations of such monomers and/or oligomers may be used to form the pore-filling polymer.

In certain embodiments, the (meth)acrylate-containing monomers and/or oligomers may be selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, and a polyester tetra-acrylate. Various combinations of such monomers and/or oligomers may be used to form the pore-filling polymer.

In certain embodiments, the starting monomers and/or oligomers include one or more of the following:

(a) di(meth)acryl-containing compounds such as dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, and tripropylene glycol diacrylate;
(b) tri(meth)acryl-containing compounds such as trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), and trimethylolpropane triacrylate;
(c) higher functionality (meth)acryl-containing compounds (i.e., higher than tri-functional) such as ditrimethylolpropane tetraacrylate, dipentaerythritol pentaacrylate, ethoxylated (4) pentaerythritol tetraacrylate, pentaerythritol tetraacrylate, and caprolactone modified dipentaerythritol hexaacrylate;
(d) oligomeric (meth)acryl compounds such as, for example, urethane acrylates, polyester acrylates, epoxy acrylates, silicone acrylates, polyacrylamide analogues of the foregoing, and combinations thereof (such compounds are widely available from vendors such as, for example, Sartomer Company, Exton, Pa., UCB Chemicals Corporation, Smyrna, Ga., and Aldrich Chemical Company, Milwaukee, Wis.);
(e) perfluoroalkyl meth(acryl)-containing compounds such as 1H,1H,6H,6H-perfluorohydroxyldiacrylate, 1H,1H-2,2,3,3,4,4,4-heptafluorobutyl acrylate, and perfluorocyclohexyl)methyl acrylate;
(f) charged meth(acryl)-containing compounds such as acrylic acid, 2-acrylamido-2-methylpropanesulfonic acid (AMPS), and [3-(methacryloylamino)propyl]trimethylammonium chloride solution; and
(g) polar polymerizable compounds such as 2-hydroxyethyl(meth)acrylate (HEMA), N-vinyl acetamide, N-vinyl pyrrolidone, (meth)acrylamide, and glycerol methacrylate.

In certain embodiments, the pore-filling polymer is a polyethylene glycol (PEG) polymer or copolymer.

In certain embodiments, the pore-filling polymer includes a major amount of crosslinked multifunctional (meth)acrylate. For example, an asymmetric composite membrane of the present disclosure may include: a porous substrate having opposite first and second major surfaces, and a plurality of pores; and a pore-filling polymer disposed in at least some of the pores so as to form a continuous layer having a thickness, with the amount of the pore-filling polymer at, or adjacent to, the first major surface being greater than the amount of the pore-filling polymer at, or adjacent to, the second major surface, wherein the pore-filling polymer comprises a major amount of crosslinked multifunctional (meth)acrylate.

In certain embodiments, the pore-filling polymer may include additives such as polymeric additives, particulate, photoinitiators, or combinations thereof.

In some embodiments, the pore-filling polymer may include one or more polymeric additives (i.e., an additive that is a polymer and not further polymerizable). Examples of such polymeric additives include polyacrylic acid, polymethacrylic acid, polyacrylamide or its copolymers, polyethylene oxide, polyvinyl alcohol, poly(ethylene-co-vinyl alcohol) (EVAL), poly(N-vinylpyrrolidone), and combinations thereof (i.e., mixtures or copolymers thereof). The optional polymeric additive preferably has a strong affinity with the pore-filling polymer so that the latter is reinforced by the former. A polymeric additive preferably enter pores with the polymerizable starting materials thereby forming an interpenetrating polymer network. The swelling of the pore-filling polymer is believed to be further restrained by the formation of such interpenetrating polymer network (one polymer is intertwined with another polymer network on a polymeric scale). The molecular weight (weight average) of the polymeric additive typically varies from 1,000 to 500,000. The amount of polymeric additive may be at least 0.20 weight percent (wt-%), or at least 1%, or at least 2.5%, based on the total amount of pore-filling polymer plus polymeric additive. The amount of polymeric additive may be up to 5 wt-%, or up to 25%, or up to 75%, based on the total amount of pore-filling polymer plus polymeric additive.

In some embodiments, the pore-filling polymer may include a particulate or a plurality of particulates. Examples of suitable particulates include colloidal silica, colloidal titania, colloidal zirconia, colloidal alumina, colloidal vanadia, colloidal chromia, colloidal iron oxide, colloidal antimony oxide, colloidal tin oxide, and mixtures thereof. In certain embodiments, such particulates may have a particle size of 2 nm to 50 nm. They may be used as bridges to prevent collapse of the filled polymer and/or be selective for particular liquids (e.g., ethanol).

Other optional additives that may be included in the pore-filling polymers include photoinitiators. Exemplary photoinitiators for initiating free-radical polymerization of (meth)acrylates, for example, include benzoin and its derivatives such as alpha-methylbenzoin; alpha-phenylbenzoin; alpha-allylbenzoin; alpha-benzylbenzoin; benzoin ethers such as benzil dimethyl ketal (available, for example, under the trade designation IRGACURE 651 from Ciba Specialty Chemicals, Tarrytown, N.Y.), benzoin methyl ether, benzoin ethyl ether, benzoin n-butyl ether; acetophenone and its derivatives such as 2-hydroxy-2-methyl-1-phenyl-1-propanone (available, for example, under the trade designation DAROCUR 1173 from Ciba Specialty Chemicals) and 1-hydroxycyclohexyl phenyl ketone (available, for example, under the trade designation IRGACURE 184 from Ciba Specialty Chemicals); 2-methyl-1-[4-(methylthio)phenyl]-2-(4-morpholinyl)-1-propanone (available, for example, under the trade designation IRGACURE 907 from Ciba Specialty Chemicals); 2-benzyl-2-(dimethlamino)-1-[4-(4-morpholinyl)phenyl]-I-butanone (available, for example, as IRGACURE 369 from Ciba Specialty Chemicals). Other useful photoinitiators include pivaloin ethyl ether, anisoin ethyl ether; anthraquinones, such as anthraquinone, 2-ethylanthraquinone, l-chloroanthraquinone, 1,4-dimethyl anthraquinone, 1-methoxyanthraquinone, benzanthraquinonehalomethyltriazines; benzophenone and its derivatives; iodonium salts and sulfonium salts; titanium complexes such as bis(eta.5-2,4-cyclopentadien-1-yl)bis[2,6-difluoro-3-(1H-pyrrol-1-yl)phenyl]titanium (obtained under the trade designation IRGACURE 784), mono- and bis-acylphosphines (available, for example, from Ciba Specialty Chemicals as IRGACURE 1700, IRGACURE 1800, IRGACURE 1850, and DAROCUR 4265).

### Ionic Liquids

In certain embodiments, composite membranes of the present disclosure further include one or more ionic liquids (i.e., liquid ionic compounds) mixed with one or more pore-filling polymers.

Such composite membranes demonstrate improved performance (e.g., flux) over the same composite membranes without the ionic liquids. Improved performance may be demonstrated by increased flux while maintaining good high octane compound (e.g., alcohol, such as ethanol) selectivity.

An ionic liquid is a compound that is a liquid under separation conditions. It may or may not be a liquid during mixing with the pore-filling polymer, application to a substrate, storage, or shipping. In certain embodiments, the desired ionic liquid is liquid at a temperature of less than 100° C., and in certain embodiments, at room temperature.

Ionic liquids are salts in which the cation(s) and anion(s) are poorly coordinated. At least one of the ions is organic and at least one of the ions has a delocalized charge. This prevents the formation of a stable crystal lattice, and results in such materials existing as liquids at the desired temperature, often at room temperature, and at least, by definition, at less than 100° C.

In certain embodiments, the ionic liquid includes one or more cations selected from quaternary ammonium, imidazolium, pyrazolium, oxazolium, thiazolium, triazolium, pyridinium, piperidinium, pyridazinium, pyrimidinium, pyrazinium, pyrrolidinium, phosphonium, trialkylsulphonium, pyrrole, and guanidium. Combinations of compounds with different cations may be used, or compounds with combinations of different cations may be used, or both.

In certain embodiments, the ionic liquid includes one or more anions selected from Cl⁻, Br⁻, I⁻, HSO₄⁻, NO₃⁻, SO₄²⁻, CH₃SO₃⁻, N(SO₂CF₃)₂⁻, CF₃SO₃⁻, B(CN)₄⁻, C₄F₉SO₃⁻, PF₆⁻, N(CN)₄⁻, C(CN)₄⁻, BF₄⁻, Ac⁻, SCN⁻, HSO₄⁻, CH₃SO₄⁻, C₂H₅SO₄⁻, and C₄H₉SO₄⁻. Combinations of compounds with different anions may be used, or compounds with combinations of different anions may be used, or both.

In certain embodiments, the ionic liquid is selected from 1-ethyl-3-methyl imidazolium tetrafluoroborate (Emim-BF₄), 1-ethyl-3-methyl imidazolium trifluoromethane sulfonate (Emim-TFSA), 3-methyl-N-butyl-pyridinium tetrafluoroborate, 3-methyl-N-butyl-pyridinium trifluoromethanesulfonate, N-butyl-pyridinium tetrafluoroborate, 1-butyl-2,3-dimethylimidazolium tetrafluoroborate, 1-butyl-2,3-dimethylimidazolium trifluoromethanesulfonate, 1-ethyl-3-methylimidazolium chloride, 1-butyl-3-ethylimidazolium chloride, 1-butyl-3-methylimidazolium chloride, 1-butyl-3-methylimidazolium bromide, 1-methyl-3-propylimidazolium chloride, 1-methyl-3-hexylimidazolium chloride, 1-methyl-3-octylimidazolium chloride, 1-methyl-3-decylimidazolium chloride, 1-methyl-3-dodecylimidazolium chloride, 1-methyl-3-hexadecylimidazolium chloride, 1-methyl-3-octadecylimidazolium chloride, 1-ethylpyridinium bromide, 1-ethylpyridinium chloride, 1-butylpyridinium chloride, and 1-benzylpyridinium bromide, 1-butyl-3-methylimidazolium iodide, 1-butyl-3-methylimidazolium nitrate, 1-ethyl-3-methylimidazolium bromide, 1-ethyl-3-methylimidazolium iodide, 1-ethyl-3-methylimidazolium nitrate, 1-butylpyridinium bromide, 1-butylpyridinium iodide, 1-butylpyridinium nitrate, 1-butyl-3-methylimidazolium hexafluorophosphate, 1-octyl-3-methylimidazolium hexafluorophosphate, 1-octyl-3-methylimidazolium tetrafluoroborate, 1-ethyl-3-methylimidazolium ethylsulfate, 1-butyl-3-methylimidazolium acetate, 1-butyl-3-methylimidazolium trifluoroacetate, 1-butyl-3-methyl imidazolium bis(trifluormethylsulfonyl)imide (Bmim-Tf₂N), and combinations thereof.

### Amorphous Fluorochemical Films

In certain embodiments, composite membranes of the present disclosure further include an amorphous fluorochemical film disposed on the composite membrane. Typically, the film is disposed on the side of the composite membrane the feed mixture enters.

In certain embodiments, the amorphous fluorochemical film is deposited on top of the porous substrate so as to protect the pore-filling polymer. The amorphous fluorochemical film may fill a portion of the porous substrate's pores above the pore filling polymer.

In certain embodiments, such composite membranes demonstrate improved durability over the same composite membranes without the amorphous fluorochemical film. Improved durability may be demonstrated by reduced mechanical damage (e.g., abrasions, scratches, or erosion, or crack generation upon membrane folding), reduced fouling, reduced chemical attack, and/or reduced performance decline after exposure to gasoline or ethanol/gasoline mixture under separation conditions.

In certain embodiments, such composite membranes demonstrate improved performance over the same composite membranes without the amorphous fluorochemical film. Improved performance may be demonstrated by increased flux.

In certain embodiments, such amorphous fluorochemical film typically has a thickness of at least 0.001 μm, or at least 0.03 μm. In certain embodiments, such amorphous fluorochemical film typically has a thickness of up to and including 5 μm, or up to and including 0.1 μm.

In certain embodiments, the amorphous fluorochemical film is a plasma-deposited fluorochemical film, as described in U.S. Pat. Pub. 2003/0134515.

In certain embodiments, the plasma-deposited fluorochemical film is derived from one or more fluorinated compounds selected from: linear, branched, or cyclic saturated perfluorocarbons; linear, branched, or cyclic unsaturated perfluorocarbons; linear, branched, or cyclic saturated partially fluorinated hydrocarbons; linear, branched, or cyclic unsaturated partially fluorinated hydrocarbons; carbonyl fluorides; perfluorohypofluorides; perfluoroether compounds; oxygen-containing fluorides; halogen fluorides; sulfur-containing fluorides; nitrogen-containing fluorides; silicon-containing fluorides; inorganic fluorides (such as aluminum fluoride and copper fluoride); and rare gas-containing fluorides (such as xenon difluoride, xenon tetrafluoride, and krypton hexafluoride).

In certain embodiments, the plasma-deposited fluorochemical film is derived from one or more fluorinated compounds selected from CF₄, SF₆, C₂F₆, C₃F₈, C₄F₁₀, C₅F₁₂, C₆F₁₄, C₇F₁₆, C₈F₁₈, C₂F₄, C₃F₆, C₄F₈, C₅F₁₀, C₆F₁₂, C₄F₆, C₇F₁₄, C₈F₁₆, CF₃COF, CF₂(COF)₂, C₃F₇COF, CF₃OF, C₂F₅OF, CF₃COOF, CF₃OCF₃, C₂F₅OC₂F₅, C₂F₄OC₂F₄, OF₂, SOF₂, SOF₄, NOF, ClF₃, IF₅, BrF₅, BrF₃, CF₃I, C₂F₅I, N₂F₄, NF₃, NOF₃, SiF₄, SiF₄, Si₂F₆, XeF₂, XeF₄, KrF₂, SF₄, SF₆, monofluorobenzene, 1,2-difluorobenzene, 1,2,4-trifluorobenzene, pentafluorobenzene, pentafluoropyridine, and pentafluorotolenene.

In certain embodiments, the plasma-deposited fluorochemical film is derived from one or more hydrocarbon compounds in combination with one or more fluorinated compounds. Examples of suitable hydrocarbon compounds include acetylene, methane, butadiene, benzene, methylcyclopentadiene, pentadiene, styrene, naphthalene, and azulene.

Typically, fluorocarbon film plasma deposition occurs at rates ranging from 1 nanometer per second (nm/sec) to 100 nm/sec depending on processing conditions such as pressure, power, gas concentrations, types of gases, and the relative size of the electrodes. In general, deposition rates increase with increasing power, pressure, and gas concentration. Plasma is typically generated with RF electric power levels of at least 500 watts and often up to and including 8000 watts, with a typical moving web speed or at least 0.3 meter per minute (m/min) and often up to and including 90 m/min. The gas flow rates, e.g., of the fluorinated compound and the optional hydrocarbon compound, is typically at least 10 (standard cubic centimeters per minutes) sccm and often up to and including 5000 sccm. In some embodiments, the fluorinated compound is carried by an inert gas such as argon, nitrogen, helium, etc.

In certain embodiments, the amorphous fluorochemical film includes an amorphous glassy perfluoropolymer having a Tg (glass transition temperature) of at least 100° C.

Examples of suitable amorphous glassy perfluoropolymers include a copolymer of perfluoro-2,2-dimethyl-1,3-dioxole (PDD) and polytetrafluoroethylene (TFE) (such as those copolymers available under the trade names TEFLON AF2400 and TEFLON AF1600 from DuPont Company), a copolymer of 2,2,4-trifluoro-5-trifluoromethoxy-1,3-dioxole (TTD) and TFE (such as those copolymers available under the trade names HYFLON AD60 and HYFLON AD80 from Solvay Company), and a copolymer of TFE and cyclic perfluoro-butenylvinyl ether (such as the copolymer available under the trade name CYTOP from Asahi Glass, Japan).

In certain embodiments, such amorphous glassy perfluoropolymer is a perfluoro-dioxole homopolymer or copolymer such as a copolymer of perfluoro-2,2-dimethyl-1,3-dioxole (PDD) and polytetrafluoroethylene (TFE), and a copolymer of 2,2,4-trifluoro-5-trifluoromethoxy-1,3-dioxole (TTD) and TFE.

In certain embodiments, such amorphous glassy perfluoropolymer is deposited out of solution. Exemplary solvents for use in deposition of the amorphous glassy perfluoropolymer include those available from 3M Company under the trade names FLUORINERT FC-87, FC-72, FC-84, and FC-770, as well as NOVEC HFE-7000, HFE-7100, HFE-7200, HFE-7300, and HFE-7500.

### Methods of Making Composite Membranes

Well-known techniques may be used to make the asymmetric composite membranes of the present disclosure.

Typically, a curable pore-filling polymer composition (i.e., “pore-filling polymer coating solution” or simply “pore-filling coating solution”) may be prepared by one or more monomers and/or oligomers with optional additives in a suitable amount of a liquid (e.g., deionized water or organic solvents). If an organic solvent is used, it may include dibutyl sebecate, glycerol triacetate, methanol, ethanol, propanol, isopropanol, etc. Preferably, it is a volatile organic solvent for easy solution saturation or diffusion into the pores.

Typically, the pore-filling coating solution may be applied to a selected porous substrate by a variety of techniques such as saturation or immersion techniques (e.g., dip coating), knife coating, slot coating, slide coating, curtain coating, rod or bar coating, roll coating, gravure coating, spin coating, spraying coating, etc. Monomer and/or oligomer concentration may range from 0.5% to 100%. Monomer with polar groups or charged groups such as 2-acrylamido-2-methylpropanesulfonic acid (AMPS) may be added into the coating solution to increase ethanol selectivity.

For example, a porous substrate may be saturated in a pore-filling coating solution of monomers and/or oligomers of a pore-filling polymer (e.g., a polyethylene glycol diacrylate, etc.) in deionized water. Typically, the substrate may be separated from the liquid (e.g., volatile organic solvent) before or after irradiation. Preferably, upon removal from the solution, the substrate may be exposed to irradiation, such as UV irradiation. This can be done for example, on a moving belt. Any uncured pore-filling coating solution may be washed away, and then the composite membrane dried.

Either an ionic liquid can be mixed in the coating composition and applied to the porous support at one pass, or an ionic liquid dissolved in a solvent can be over-coated onto the polymeric ionomer coated membrane. The ionic liquid may diffuse into the polymeric ionomer layer.

An amorphous fluorocarbon film may be applied after the polymeric ionomer composition is coated in or on a substrate. The fluorocarbon film can be formed out of a solution or deposited by plasma fluorination.

Commercially available porous substrates may be supplied with a humectant, such as glycerol, that fills and/or coats the pores of the substrate. Typically, this is done to prevent small pores from collapsing during drying process and storage, for example. This humectant may or may not be washed out before using. Typically, however, the humectant is washed out by the process of filling the pores with the pore-filling coating solution. Preferably, a substrate is obtained and used without a humectant.

Suitable methods for preparing preferred asymmetric composite membranes of the present disclosure are described in International Publication No. WO 2010/002501 (Zhou et al.).

### Uses

Composite membranes, particularly asymmetric composite membranes, of the present disclosure may be used in various separation methods. Such separation methods include pervaporation, vapor permeation, gas separation, nanofiltration, organic solvent nanofiltration, and combinations thereof (e.g., a combination of pervaporation and vapor permeation). The composite membranes, particularly the asymmetric composite membranes, of the present disclosure are particularly useful in pervaporation methods. Pervaporation may be used for desulfurization of gasoline, dehydration of organic solvents, isolation of aroma components, and removal of volatile organic compounds from aqueous solutions.

Preferred methods of the present disclosure involve use of the composite membranes, particularly the asymmetric composite membranes, in pervaporation, particularly pervaporating alcohol from an alcohol and gasoline mixture, or other high octane compounds (those organic compounds having an octane rating of at least 87 (AKI)) from a fuel that includes such high octane compounds (e.g., gasoline). This latter method results in concentrating high octane compounds for later use.

Well-known separation techniques may be used with the composite membranes of the present disclosure. For example, nanofiltration techniques are described in U.S. Pat. Pub. No. 2013/0118983 (Linvingston et al.), U.S. Pat. No. 7,247,370 (Childs et al.), and U.S. Pat. Pub. No. 2002/0161066 (Remigy et al.). Pervaporation techniques are described in U.S. Pat. No. 7,604,746 (Childs et al.) and EP 0811420 (Apostel et al.). Gas separation techniques are described in Journal of Membrane Sciences, vol. 186, pages 97-107 (2001).

Pervaporation separation rate is typically not constant during a depletion separation. The pervaporation rate is higher when the feed concentration of the selected material is higher than near the end of the separation when the feed concentration of the selected material is lower and this rate is typically not linear with concentration. At high feed concentration the separation rate is high and the feed concentration of the selected material and flux falls rapidly, but this concentration and flux changes very slowly as the limit of depletion is reached.

Typical conditions used in separation methods of the present disclosure include fuel temperatures of from −20° C. (or from 20° C. or from room temperature) up to and including 120° C. (or up to and including 95° C.), fuel pressures of from 10 pounds per square inch (psi) (69 kPa) up to and including 400 psi (2.76 MPa) (or up to and including 100 psi (690 kPa)), fuel flow rates of 0.1 liter per minute (L/min) up to and including 20 L/min, and vacuum pressures from 20 Torr (2.67 kPa) to and including ambient pressure (i.e., 760 Torr (101 kPa)).

The performance of a composite membrane is mainly determined by the properties of the pore-filling polymer anchored within the pores of the porous (support) membrane.

The efficiency of a pervaporation membrane may be expressed as a function of its selectivity and of its specific flux. The selectivity is normally given as the ratio of the concentration of the better permeating component to the concentration of the poorer permeating component in the permeate, divided by the corresponding concentration ratio in the feed mixture to be separated:

α=(y_{w}/yᵢ)/(x_{w}/xᵢ)

wherein y_{w} and yᵢ are the content of each component in the permeate, and x_{w} and xᵢ are the content of each component in the feed, respectively. Sometimes, the permeate concentration is defined as the separation efficiency if the feed component is relatively consistent.

The trans-membrane flux is a function of the composition of the feed. It is usually given as permeate amount per membrane area and per unit time, e.g., kilogram per meter squared per hour (kg/m²/hr).

In certain embodiments of the present disclosure, the pore-filling polymer exhibits a high octane compound (e.g., an alcohol) selectivity in the range of from at least 30% up to and including 100%. In this context, “high octane compound selectivity” (e.g., “alcohol selectivity”) means the amount of high octane compound (e.g., alcohol) in the gasoline (or other such fuel)/high octane compound (e.g., alcohol) mixture that diffuses through to the output side of the asymmetric composite membrane. In accordance with the present disclosure, the high octane compound (e.g., alcohol) selectivity of the pore-filling polymer may include, in increments of 1%, any range between 30% and 100%. For example, the alcohol selectivity may be in the range of from 31% up to 99%, or 40% to 100%, or 50% to 95%, etc.

In certain embodiments, the pore-filling polymer in the composite membrane exhibits an average high octane compound (e.g., alcohol) permeate flux, e.g., from a high octane compound/fuel mixture (e.g., an alcohol/gasoline mixture) in the range of from at least 0.2 kg/m²/hr (in certain embodiments, at least 0.3 kg/m²/hr), and in increments of 10 g/m²/hr, up to and including 30 kg/m²/hr. For example, the average ethanol flux from E10 (10% ethanol) to E2 (2% ethanol) standard include in the range of from 0.2 kg/m²/hr to 20 kg/m²/hr. Preferred processing conditions used for such flux measurement include: a feed temperature of from −20° C. (or from 20° C.) up to and including 120° C. (or up to and including 95° C.), a permeate vacuum pressure from 20 Torr (2.67 kPa) to and including 760 Torr (101 kPa), a feed pressure of from 10 psi (69 kPa) up to and including 400 psi (2.76 MPa) (or up to and including 100 psi (690 kPa)). For example, these processing conditions would be suitable for an alcohol (e.g., ethanol) concentration in feed gasoline of from 2% up to and including 20%.

In certain embodiments of the present disclosure, the pore-filling polymer in the composite membrane can exhibit an average high octane compound (e.g., ethanol) permeate flux, in increments of 10 g/m²/hour, between the below-listed upper and lower limits (according to Method 1 and/or Method 2 in the Examples Section). In certain embodiments, the average high octane compound (e.g., alcohol such as ethanol) permeate flux may be at least 100 g/m²/hour, or at least 150 g/m²/hour, or at least 200 g/m²/hour, or at least 250 g/m²/hour, or at least 300 g/m²/hour, or at least 350 g/m²/hour, or at least 400 g/m²/hour, or at least 450 g/m²/hour, or at least 500 g/m²/hour, or at least 550 g/m²/hour, or at least 600 g/m²/hour, or at least 650 g/m²/hour, or at least 700 g/m²/hour, or at least 750 g/m²/hour, or at least 800 g/m²/hour, or at least 850 g/m²/hour, or at least 900 g/m²/hour, or at least 950 g/m²/hour, or at least 1000 g/m²/hour. In certain embodiments, the average high octane compound (e.g., alcohol such as ethanol) permeate flux may be up to 30 kg/m²/hour, or up to 25 kg/m²/hour, or up to 20 kg/m²/hour, or up to 15 kg/m²/hour, or up to 10 kg/m²/hour, or up to 5 kg/m²/hour. For example, the average permeate flux may be in the range of from 300 g/m²/hour up to 20 kg/m²/hour, or 350 g/m²/hour up to 20 kg/m²/hour, or 500 g/m²/hour up to 10 kg/m²/hour, etc. It may be desirable for the pore-filling polymer to exhibit an average permeate flux of at least 320 g/m²/hour, when the asymmetric composite membrane is assembled into 0.3 to 5 liter volume cartridge such that the cartridge will produce the desired amount of flux to meet the system requirements. The system requirements are defined by internal combustion engines that require ethanol flux. One example is a Japan Society of Automotive Engineers technical paper JSAE 20135048 titled “Research Engine System Making Effective Use of Bio-ethanol-blended Fuels.”

Preferred processing conditions used for such flux measurement include: a feed temperature of from −20° C. (or from 20° C.) up to and including 120° C. (or up to and including 95° C.), a permeate vacuum pressure from 20 Torr (2.67 kPa) to and including 760 Torr (101 kPa), a feed pressure of from 69 kPa up to and including 2.76 MPa (or up to and including 690 kPa). For example, these processing conditions would be suitable for an alcohol (e.g., ethanol) concentration in feed gasoline of from 2% up to and including 20%.

Composite membranes of the present disclosure may be incorporated into cartridges (i.e., modules), in particular cartridges for separating alcohol and/or other high octane compounds from mixtures that include gasoline or other such fuels. Suitable cartridges include, for example, spiral-wound modules, plate and frame modules, tubular modules, hollow fiber modules, pleated cartridge, and the like.

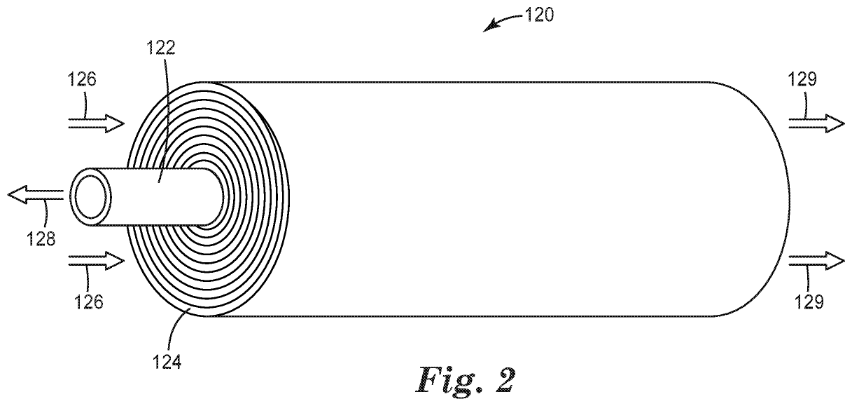

FIG. 2 is an illustration of an exemplary module 120 (specifically, a spiral-wound module) that includes a support tube 122, an exemplary composite membrane 124 of the present disclosure wound onto the support tube 122. During use, a mixture of liquids to be separated (e.g., alcohol and gasoline mixture) enters the module 120 and flows along the direction of arrows 126 into the composite membrane 124. As the mixture flows past the composite membrane layers, the liquid that is less permeable in the pore-filling polymer (e.g., gasoline or other such fuels) is not absorbed by the pore-filling polymer, while the more permeable liquid (e.g., alcohol and/or aromatics) is absorbed in and passes through the pore-filling polymer and then flows out of the center of the support tube 122 along the direction of arrow 128. For example, a high concentration of alcohol (typically with a small amount of gasoline), which is separated from an alcohol/gasoline mixture, flows out of the center of the support tube 122 as vapor and/or liquid along the direction of arrow 128, and the resultant mixture with a lower concentration of alcohol than present in the mixture that enters the composite membrane flows out of the composite membrane along the direction of arrows 129.

In certain embodiments, an exemplary cartridge has a volume in the range of from 200 milliliters (mL), or 500 mL, up to and including 5.000 liters (L). In accordance with the present disclosure, the volume of the cartridge may include, in increments of 10 mL, any range between 200 mL, or 500 mL, and 5.000 L. For example, the cartridge volume may be in the range of from 210 mL up to 4.990 L, or 510 mL up to 4.990 L, or 300 mL up to 5.000 L, or 600 mL up to 5.000 L, or 1.000 L up to 3.000 L, etc. In certain embodiments, the cartridge has a volume of 1.000 L. In certain embodiments, the cartridge has a volume of 0.800 L

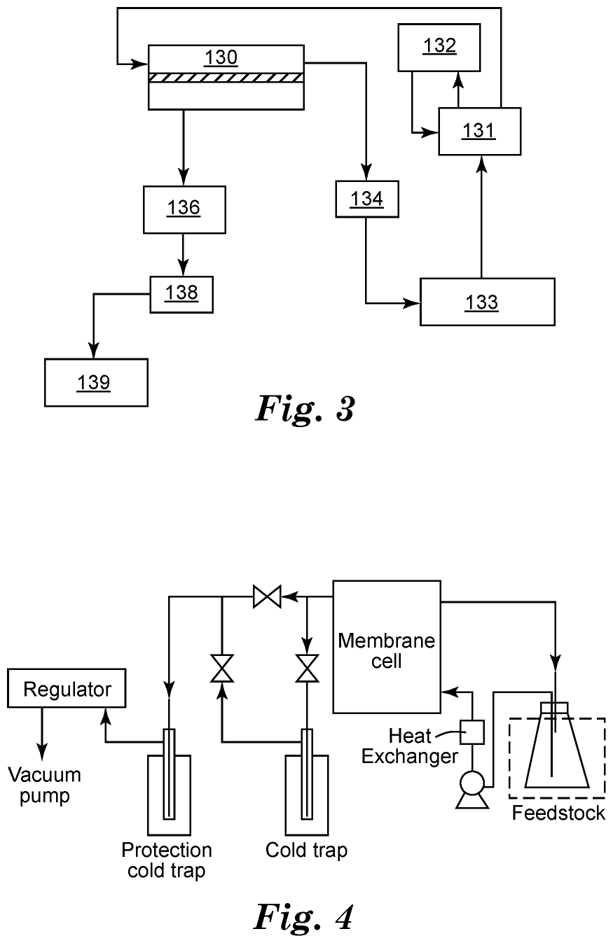

Cartridges that include composite membranes (e.g., asymmetric composite membranes) of the present disclosure may be incorporated into fuel separation systems, which may be used in, or in conjunction with, engines such as flex-fuel engines. An exemplary fuel separation system is shown in FIG. 3, which employs a membrane pervaporation method (PV method) to separate high ethanol fraction gasoline from gasoline containing ethanol. Typically, gasoline is introduced into an inlet of a membrane separation unit 130 after being passed through a heat exchanger 131 (which is connected to engine coolant 132) from a main fuel storage tank 133. A low-ethanol fraction fuel from the membrane separation unit 130 is returned to the main fuel storage tank 133 after being cooled as it passes through a radiator 134. The ethanol rich vapor which came out of membrane separation unit 130 is typically passed through a condenser 136 where it is condensed under negative pressure produced by vacuum pump 138 and then collected in an ethanol tank 139.

In certain embodiments, a fuel separation system includes one or more cartridges, which may be in series or parallel, which include composite membranes of the present disclosure.

### EXEMPLARY EMBODIMENTS

Embodiment 1 is a composite membrane for selectively separating (e.g., pervaporating) a first fluid (e.g., first liquid such as an alcohol and/or other high octane compound) from a feed mixture comprising the first fluid (e.g., first liquid) and a second fluid (e.g., second liquid such as gasoline), the composite membrane comprising: a porous substrate comprising opposite first and second major surfaces, and a plurality of pores; and a pore-filling polymer disposed in at least some of the pores so as to form a layer having a thickness within the porous substrate; wherein the pore-filling polymer is more permeable to the first fluid (e.g., first liquid) than the second fluid (e.g., second liquid); wherein the composite membrane further comprises at least one of:

(a) an ionic liquid mixed with the pore-filling polymer; or

(b) an amorphous fluorochemical film disposed on the composite membrane.

Embodiment 2 is the composite membrane further comprises an amorphous fluorochemical film disposed on the composite membrane.

Embodiment 3 is the composite membrane according to embodiment 2 wherein the amorphous fluorochemical film has a thickness of 0.001 μm to 5 μm (and in some embodiments 0.03 μm to 0.1 μm).

Embodiment 4 is the composite membrane according to embodiment 2 or 3 wherein the amorphous fluorochemical film is a plasma-deposited fluorochemical film.

Embodiment 5 is the composite membrane according to embodiment 4 wherein the plasma-deposited fluorochemical film is derived from one or more fluorinated compounds selected from:

linear, branched, or cyclic saturated perfluorocarbons;

linear, branched, or cyclic unsaturated perfluorocarbons;

linear, branched, or cyclic saturated partially fluorinated hydrocarbons;

linear, branched, or cyclic unsaturated partially fluorinated hydrocarbons;

carbonylfluorides;

perfluorohypofluorides;

perfluoroether compounds;

oxygen-containing fluorides;

halogen fluorides;

sulfur-containing fluorides;

nitrogen-containing fluorides;

silicon-containing fluorides;

inorganic fluorides (such as aluminum fluoride and copper fluoride); and

rare gas-containing fluorides (such as xenon difluoride, xenon tetrafluoride, and krypton hexafluoride).

Embodiment 6 is the composite membrane according to embodiment 5 wherein the plasma-deposited fluorochemical film is derived from one or more fluorinated compounds selected from CF₄, SF₆, C₂F₆, C₃F₈, C₄F₁₀, C₅F₁₂, C₆F₁₄, C₇F₁₆, C₈F₁₈, C₂F₄, C₃F₆, C₄F₈, C₅F₁₀, C₆F₁₂, C₄F₆, C₇F₁₄, C₈F₁₆, CF₃COF, CF₂(COF)₂, C₃F₇COF, CF₃OF, C₂F₅OF, CF₃COOF, CF₃OCF₃, C₂F₅OC₂F₅, C₂F₄OC₂F₄, OF₂, SOF₂, SOF₄, NOF, ClF₃, IF₅, BrF₅, BrF₃, CF₃I, C₂F₅I, N₂F₄, NF₃, NOF₃, SiF₄, SiF₄, Si₂F₆, XeF₂, XeF₄, KrF₂, SF₄, SF₆, monofluorobenzene, 1,2-difluorobenzene, 1,2,4-trifluorobenzene, pentafluorobenzene, pentafluoropyridine, and pentafluorotolenene.

Embodiment 7 is the composite membrane according to any one of embodiments 2 through 6 wherein the plasma-deposited fluorochemical film is derived from one or more hydrocarbon compounds in combination with one or more fluorinated compounds.

Embodiment 8 is the composite membrane according to embodiment 7 wherein the hydrocarbon compound is selected from acetylene, methane, butadiene, benzene, methylcyclopentadiene, pentadiene, styrene, naphthalene, and azulene.

Embodiment 9 is the composite membrane according to embodiment 2 or 3 wherein the amorphous fluorochemical film comprises an amorphous glassy perfluoropolymer having a Tg of at least 100° C.

Embodiment 10 is the composite membrane according to embodiment 9 wherein the amorphous glassy perfluoropolymer comprises a copolymer of perfluoro-2,2-dimethyl-1,3-dioxole (PDD) and TFE, a copolymer of 2,2,4-trifluoro-5-trifluoromethyoxy-1,3-dioxole (TTD) and TFE, or a copolymer of TFE and cyclic perfluoro-butenylvinyl ether.

Embodiment 11 is the composite membrane according to embodiment 9 or 10 wherein the amorphous glassy perfluoropolymer is deposited out of solution.

Embodiment 12 is the composite membrane according to embodiment 1 further comprises an ionic liquid mixed with the pore-filling polymer.

Embodiment 13 is the composite membrane according to embodiment 12 wherein the ionic liquid comprises a cation selected from imidazolium, pyrazolium, oxazolium, thiazolium, triazolium, pyridinium, pyridazinium, pyrimidinium, pyrazinium, and combinations thereof.

Embodiment 14 is the composite membrane according to embodiment 12 or 13 wherein the ionic liquid comprises an anion selected from Cl⁻, Br⁻, I⁻, HSO₄⁻, NO₃⁻, SO₄²⁻, CH₃SO₃⁻, N(SO₂CF₃)₂⁻, CF₃SO₃⁻, B(CN)₄⁻, C₄F₉SO₃⁻, PF₆⁻, N(CN)₄⁻, C(CN)₄⁻, BF₄⁻, Ac⁻, SCN⁻, HSO₄⁻, CH₃SO₄⁻, C₂H₅SO₄⁻, C₄H₉SO₄⁻, and combinations thereof.

Embodiment 15 is the composite membrane according to any one of embodiments 12 through 14 wherein the ionic liquid is selected from 1-ethyl-3-methyl imidazolium tetrafluoroborate (Emim-BF₄), 1-ethyl-3-methyl imidazolium trifluoromethane sulfonate (Emim-TFSA), 3-methyl-N-butyl-pyridinium tetrafluoroborate, 3-methyl-N-butyl-pyridinium trifluoromethanesulfonate, N-butyl-pyridinium tetrafluoroborate, 1-butyl-2,3-dimethylimidazolium tetrafluoroborate, 1-butyl-2,3-dimethylimidazolium trifluoromethanesulfonate, 1-ethyl-3-methylimidazolium chloride, 1-butyl-3-ethylimidazolium chloride, 1-butyl-3-methylimidazolium chloride, 1-butyl-3-methylimidazolium bromide, 1-methyl-3-propylimidazolium chloride, 1-methyl-3-hexylimidazolium chloride, 1-methyl-3-octylimidazolium chloride, 1-methyl-3-decylimidazolium chloride, 1-methyl-3-dodecylimidazolium chloride, 1-methyl-3-hexadecylimidazolium chloride, 1-methyl-3-octadecylimidazolium chloride, 1-ethylpyridinium bromide, 1-ethylpyridinium chloride, 1-butylpyridinium chloride, and 1-benzylpyridinium bromide, 1-butyl-3-methylimidazolium iodide, 1-butyl-3-methylimidazolium nitrate, 1-ethyl-3-methylimidazolium bromide, 1-ethyl-3-methylimidazolium iodide, 1-ethyl-3-methylimidazolium nitrate, 1-butylpyridinium bromide, 1-butylpyridinium iodide, 1-butylpyridinium nitrate, 1-butyl-3-methylimidazolium hexafluorophosphate, 1-octyl-3-methylimidazolium hexafluorophosphate, 1-octyl-3-methylimidazolium tetrafluoroborate, 1-ethyl-3-methylimidazolium ethylsulfate, 1-butyl-3-methylimidazolium acetate, 1-butyl-3-methylimidazolium trifluoroacetate, 1-butyl-3-methyl imidazolium bis(trifluormethylsulfonyl)imide (Bmim-Tf₂N), and combinations thereof.

Embodiment 16 is the composite membrane according to any one of embodiments 1 through 15 which is an asymmetric composite membrane, wherein the amount of the pore-filling polymer at, or adjacent to, the first major surface is greater than the amount of the pore-filling polymer at, or adjacent to, the second major surface.

Embodiment 17 is the composite membrane according to any one of embodiments 1 through 16 wherein the first fluid (e.g., first liquid) is an alcohol and/or other high octane compounds such as aromatic hydrocarbons.

Embodiment 18 is the composite membrane according to any one of embodiments 1 through 17 wherein the second fluid (e.g., second liquid) is gasoline.

Embodiment 19 is the composite membrane according to any one of embodiments 1 through 18 wherein the first fluid (e.g., first liquid) is an alcohol, and the second fluid (e.g., second liquid) is gasoline.

Embodiment 20 is the composite membrane according to any one of embodiments 1 through 19 wherein the pore-filling polymer layer is a continuous layer.

Embodiment 21 is the composite membrane according to any one of embodiments 1 through 20 which is an asymmetric composite membrane for selectively pervaporating alcohol from an alcohol and gasoline mixture, wherein the asymmetric composite membrane comprises: a porous substrate comprising opposite first and second major surfaces, and a plurality of pores; and a pore-filling polymer disposed in at least some of the pores so as to form a layer having a thickness within the porous substrate, with the amount of the pore-filling polymer at, or adjacent to, the first major surface being greater than the amount of the pore-filling polymer at, or adjacent to, the second major surface; wherein the pore-filling polymer is more permeable to alcohol than gasoline.

Embodiment 22 is the asymmetric composite membrane according to embodiment 21 wherein the pore-filling polymer layer is a continuous layer.

Embodiment 23 is the composite membrane according to any one of embodiments 1 through 22 wherein the porous substrate is a polymeric porous substrate.

Embodiment 24 is the composite membrane according to any one of embodiments 1 through 23 wherein the porous substrate is asymmetric or symmetric (e.g., with respect to pore sizes throughout the thickness of the substrate).

Embodiment 25 is the composite membrane according to any one of embodiments 1 through 24 wherein the porous substrate comprises a nanoporous layer.

Embodiment 26 is the composite membrane according to embodiment 25 wherein the nanoporous layer is adjacent to or defines the first major surface of the porous substrate.

Embodiment 27 is the composite membrane according to any one of embodiments 1 through 26 wherein the porous substrate comprises a microporous layer.

Embodiment 28 is the composite membrane according to embodiment 27 wherein the microporous layer is adjacent to or defines the second major surface of the porous substrate.

Embodiment 29 is the composite membrane according to any one of embodiments 1 through 28 wherein the porous substrate comprises a macroporous layer.

Embodiment 30 is the composite membrane according to embodiment 29 wherein the macroporous layer is adjacent to or defines the second major surface of the porous substrate.

Embodiment 31 is the composite membrane according to any one of embodiments 1 through 30 wherein the porous substrate has a thickness measured from one to the other of the opposite major surfaces in the range of from 5 μm up to and including 500 μm.

Embodiment 32 is the composite membrane according to embodiment 25 or 26 wherein the nanoporous layer has a thickness in the range of from 0.01 μm up to and including 10 μm.

Embodiment 33 is the composite membrane according to embodiment 27 or 28 wherein the microporous layer has a thickness in the range of from 5 μm up to and including 300 μm.

Embodiment 34 is the composite membrane according to embodiment 29 or 30 wherein the macroporous layer has a thickness in the range of from 25 μm up to and including 500 μm.

Embodiment 35 is the composite membrane according to any one of embodiments 1 through 34 wherein the porous substrate comprises pores having an average size in the range of from 0.5 nanometer (nm) up to and including 1000 μm.

Embodiment 36 is the composite membrane according to any one of embodiments 25, 26, and 32, wherein the nanoporous layer comprises pores having a size in the range of from 0.5 nanometer (nm) up to and including 100 nm.

Embodiment 37 is the composite membrane according to any one of embodiments 27, 28, and 33, wherein the microporous layer comprises pores having a size in the range of from 0.01 μm up to and including 20 μm.

Embodiment 38 is the composite membrane according to any one of embodiments 29, 30, and 34, wherein the macroporous layer comprises pores having a size in the range of from 1 μm up to and including 1000 μm.

Embodiment 39 is the composite membrane according to any one of embodiments 1 through 38 wherein the pore-filling polymer is crosslinked, grafted to the porous substrate, or both.

Embodiment 40 is the composite membrane according to any one of embodiments 1 through 39 wherein the pore-filling polymer is crosslinked and/or grafted to a nanoporous substrate.

Embodiment 41 is the composite membrane according to any one of embodiments 1 through 40 wherein the starting materials for the pore-filling polymer comprise ethylenically unsaturated monomers and/or oligomers.

Embodiment 42 is the composite membrane according to embodiment 41 wherein the starting materials for the pore-filling polymer comprise (meth)acrylate-containing monomers and/or oligomers.

Embodiment 43 is the composite membrane according embodiment 42 wherein the (meth)acrylate-containing monomers and/or oligomers are selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, a urethane diacrylate, a urethane hexa-acrylate, a urethane triacrylate, a polymeric tetrafunctional acrylate, a polyester penta-acrylate, an epoxy diacrylate, a polyester triacrylate, a polyester tetra-acrylate, an amine-modified polyester triacrylate, an alkoxylated aliphatic diacrylate, an ethoxylated bisphenol di(meth)acrylate, a propoxylated triacrylate, 2-acrylamido-2-methylpropanesulfonic acid (AMPS), and combinations of such monomers and/or oligomers.

Embodiment 44 is the composite membrane of embodiment 43 wherein the (meth)acrylate-containing monomers and/or oligomers are selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, a polyester tetra-acrylate, and combinations of such monomers and/or oligomers.

Embodiment 45 is the composite membrane according to any one of embodiments 1 through 44 wherein the pore-filling polymer swells in the presence of alcohol and/or other high octane compound but not gasoline or other such fuel.

Embodiment 46 is the composite membrane according to any one of embodiments 1 through 45 wherein the pore-filling polymer is in the form of a pore-filling polymer layer that forms at least a portion of the first major surface of the porous substrate.

Embodiment 47 is the composite membrane according to any one of embodiments 1 through 46 wherein the pore-filling polymer is in the form of a pore-filling polymer layer having an exposed major surface, which coats the first major surface of the porous substrate, and an opposite major surface disposed between the opposite first and second major surfaces of the porous substrate.

Embodiment 48 is the composite membrane according to embodiment 47 wherein the exposed major surface of the pore-filling polymer layer coats all the first major surface of the porous substrate.

Embodiment 49 is the composite membrane according to any one of embodiments 1 through 48 wherein the pore-filling polymer layer has a thickness in the range of from 10 nm up to and including 20,000 nm.

Embodiment 50 is the composite membrane according to any one of embodiments 1 through 49 wherein the pore-filling polymer exhibits a high octane compound (e.g., an alcohol) selectivity in the range of from at least 30% up to and including 100%.

Embodiment 51 is the composite membrane according to any one of embodiments 1 through 50 wherein the pore-filling polymer exhibits an average alcohol permeate (e.g., alcohol from an alcohol/gasoline mixture) flux in the range of from at least 300 g/m²/hour up to and including 30 kg/m²/hour, using a feed temperature in the range of from at least −20° C. up to and including 120° C., a permeate vacuum pressure in the range from 20 Torr (2.67 kPa) to and including 760 Torr (101 kPa), a feed pressure in the range of at least 10 psi (69 kPa) up to and including 2.76 MPa, and an alcohol concentration in feed gasoline/alcohol mixture in the range of from at least 2% up to and including 20%.

Embodiment 52 is a cartridge for separating alcohol from an alcohol and gasoline mixture, the cartridge comprising an asymmetric composite membrane according to any one of embodiments 1 through 51.

Embodiment 53 is the cartridge according to embodiment 52 having a volume in the range of from 200 milliliters (mL), or from 500 mL, up to and including 5.000 liters (L).

Embodiment 54 is a fuel separation system comprising one or more cartridges (which may be in series of parallel) according to embodiment 52 or 53.

Embodiment 55 is a method of separating a first fluid (e.g., first liquid) from a mixture of the first fluid (e.g., first liquid) and a second fluid (e.g., second liquid), the method comprising contacting the mixture with an asymmetric composite membrane according to any one of embodiments 1 through 51.

Embodiment 56 is the method according to embodiment 55 wherein the first fluid (e.g., first liquid) is an alcohol and/or a high octane compound and the second fluid (e.g., second liquid) is gasoline.

Embodiment 57 is the method according to embodiment 56 which is carried out under the following conditions: a feed temperature in the range of from at least 20° C. up to and including 120° C., a permeate vacuum pressure in the range from 20 Torr (2.67 kPa) to and including 760 Torr (101 kPa), a feed pressure in the range of at least 69 kPa up to and including 2.76 MPa, and an alcohol concentration in feed gasoline/alcohol mixture in the range of from at least 2% up to and including 20%.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Materials

IRGACURE 2959, 1-[4-(2-Hydroxyethoxy)-phenyl]-2-hydroxy-2-methyl-1-propane-1-one, obtained from BASF Corp., Florham Park, N.J.
EBECRYL 350, EB350, silicone diacrylate, obtained from Cytec Industries, Smyrna, Ga.
FHDA, 1H,1H,6H,6H-perflourohexyldiacrylate, obtained from Oakwood Products, West Columbia, S.C.
GTA, glycerol triacetate, obtained from Univar USA, Redmond, Wash.
HEMA, 2-hydroxyl methacrylate, obtained from Alfa Aesar, Ward Hill, Mass.
PEGMMA, polyethylene glycol methylether methacrylate, Mn-2080, obtained from Sigma Aldrich, Milwaukee, Wis.
PPG900DA, polypropylene glycol 900 diacrylate, obtained from Sigma Aldrich, Milwaukee, Wis.
CD552, methoxy polyethylene glycol 550 monoacrylate, obtained from Sartomer, Exton, Pa.
CD553, methoxy polyethylene glycol 550 monoacrylate, obtained from Sartomer, Exton, Pa.
CN2622, polyester acrylate, obtained from Sartomer Co., Exton, Pa.
SR259, polyethylene glycol 200 diacrylate obtained from Sartomer, Exton, Pa.
SR344, polyethyleneglycol 400 diacrylate, obtained from Sartomer Company, Exton, Pa.
SR415, ethoxylated trimethylolpropane triacrylate, obtained from Sartomer, Exton, Pa.
SR454, ethoxylated 3-trimethylolpropane triacrylate, obtained from Sartomer, Exton, Pa.
SR603, polyethyleneglycol 400 dimethacrylate, Sartomer Company, Exton, Pa.
SR610, polyethyleneglycol 600 diacrylate, Sartomer Company, Exton, Pa.
TMPTA, trimethylolpropane triacrylate, obtained from Alfa Aesar, Ward Hill, Mass.
BLA020, micro porous nylon substrate, obtained from 3M Purification Inc., Meriden, Conn.
PA450, polyacrylonitrile substrate, obtained from Nanostone Water, formerly known as Sepro Membranes Inc., Oceanside, Calif.
PE2, polyethersulfone substrate, obtained from Nanostone Water, formerly known as Sepro Membranes Inc., Oceanside, Calif.
PE5, polyethersulfone substrate, obtained from Nanostone Water, formerly known as Sepro

Membranes Inc., Oceanside, Calif.

PE900 C/D, polyethersulfone substrate, obtained from Nanostone Water, formerly known as Sepro Membranes Inc., Oceanside, Calif.
AMPS, 2-acrylamido-2-methylpropanesulfonic acid, obtained from Sigma Aldrich, Milwaukee, Wis.
APS, titanium (IV) oxide powder 32 nanometer particle size, obtained from Alfa Aesar, MA
BIS, N, N′-methylenebisacrylamide, obtained from Alfa Aesar, Ward Hill, Mass.
DBS, dibutyl sebacate, obtained from Vertellus Performance Materials, Inc., Greensboro, N.C.

### NaCl, EM Science, Gibbstown, N.J.

NALCO 2326, ammonia stabilized colloidal silica, 14.5% colloidal silica as SiO₂; particle size 5 nm; obtained from Nalco Chemical Company, Naperville, Ill.
Polyacrylic acid, 50% aqueous solution, MW 5000, Alfa Aesar, Ward Hill, Mass.

### Toluene, UN1294, BDH, VWR International LLC, Radnor, Pa.

o-xylene, Alfa Aesar, Ward Hill, Mass.
1, 2, 4-trimethylbenzene, Alfa Aesar, Ward Hill, Mass.

### Heptane, UN1206, BDH, VWR International LLC, Radnor, Pa.

EMIM-TFSA, 1-ethyl-3-methylimidazolium trifluoromethanesulfonate, Sigma Aldrich, Milwaukee, Wis.
EMIM-Tf₂N, 1-ethyl-3-methylimidazolium bis(trifluoromethylsulfonyl)imide, Sigma Aldrich, Milwaukee, Wis.

### AF2400, Amorphous TEFLON, DuPont Company, Wilmington, Del.

HFE-7200, NOVEC solvent, 3M Company, St Paul, Minn.

### Ethanol, DLI Inc., King of Prussia, Pa.

E10 gasoline, blend gasoline with 10% ethanol

### Test Procedures

### Method 1

The ability of the membranes to separate ethanol from an ethanol/gasoline mixture was determined using the test apparatus depicted in FIG. 4 and the following technique. The membrane sample was mounted onto a stainless steel cell (SEPA CF II, obtained from General Electric Co., Fairfield, Conn.). The effective membrane surface area was 140 cm². A feedstock of E10 gasoline (10% ethanol) was heated by a heat exchanger and pumped through the membrane cell at a flow rate of 300-500 mL/min. The input and output temperatures of the feedstock at the inlet and outlet of the membrane cell was measured with thermometers. The permeate was collected in a cold trap cooled with liquid nitrogen. The membrane cell vacuum was controlled by a regulator connected to a vacuum pump. Testing was performed at three conditions: 70° C. feedstock temperature and 200 Torr (26.7 kPa) vacuum, 50° C. feedstock temperature and 85 Torr (11.3 kPa) vacuum, and 21-22° C. at 20 Torr (2.67 kPa) vacuum. The total permeate mass flux was calculated as:

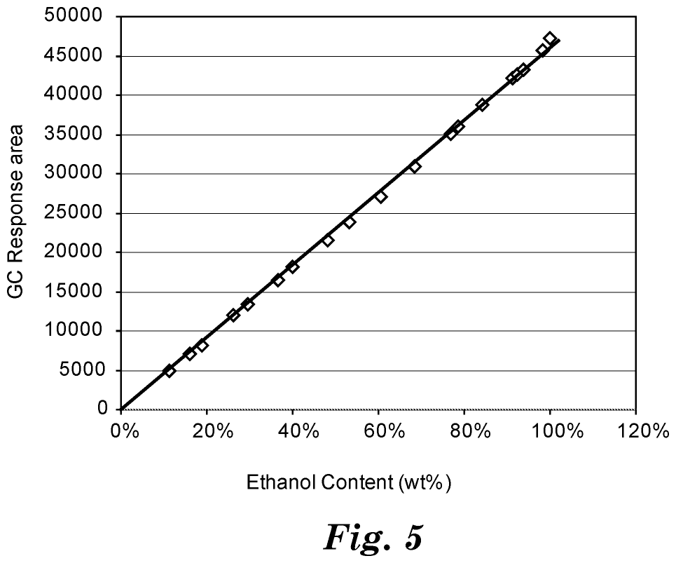

Flux=m/(A×t)

where m is the mass of the permeate in kilograms (kg); A is the effective membrane area in square meters (m²); and t is the permeate collection duration time in hours (h). The ethanol content of the permeate and the feedstock were measured by gas chromatography (GC) using a Hewlett Packard Model 5890A or 7890C gas chromatograph. The alcohol content was determined by using a calibration line shown in FIG. 5, obtained by running known concentrations of ethanol through the GC and measuring the GC response area. Then the response area measurements of the permeate and feedstock from the GC were obtained, and then using the calibration line, the % ethanol was determined. Ethanol mass flux was calculated as membrane mass flux multiplied by the ethanol concentration in the permeate.

The permeate was collected each 10 min for one measurement and five measurements were taken for each membrane testing. The average data of the last three measurements were used to represent the membrane performance.

### Method 2

The ability of the membranes to separate ethanol from an ethanol/gasoline mixture was determined as in Method 1 above except the test apparatus was run in a continuous mode after charging the initial test vessel with 1.1 liters of gasoline. Testing was conducted until the gasoline feed stream at the inlet of the membrane cell was less than 2.0 wt-%. The flow rate of the feed stream was maintained at 500 mL/min. Vacuum in the membrane permeate side was set at 200 Torr (26.7 kPa) and the average gasoline temperature at the inlet and outlet of the membrane cell was maintained at 70° C. Permeate samples were collected every 5-10 minutes. The average total mass flux was calculated based on the ethanol obtained from all the permeate samples collected over the total testing time.

### Method 3

The ability of the membranes to separate both aromatics and ethanol was determined as Method 1 except that one model fuel was used for measurement. The model fuel was formulated by mixing 60 vol % heptane, 10 vol % toluene, 10 vol % o-xylene, 10 vol % 1,2,4-trimethylbenzene and 10 vol % ethanol. The content of each component in the permeate was analyzed by GC. The total aromatic selectivity was calculated by the total aromatic content (Toluene (T), o-xylene (X) and 1,2,4-trimethylbenzene (mB)) in the permeate excluding ethanol.

$$Aromatic selectivity = \frac{{c}_{T} + {c}_{X} + {c}_{mB}}{100 \% - {c}_{EtOH}}$$

Where c_{T} is toluene content in the permeate, c_{X} is o-xylene content in the permeate, c_{mB} is 1,2,4-trimethylbenzene content in the permeate, and c_{EtOH} is ethanol content in the permeate.

### EXAMPLES

### Example 1

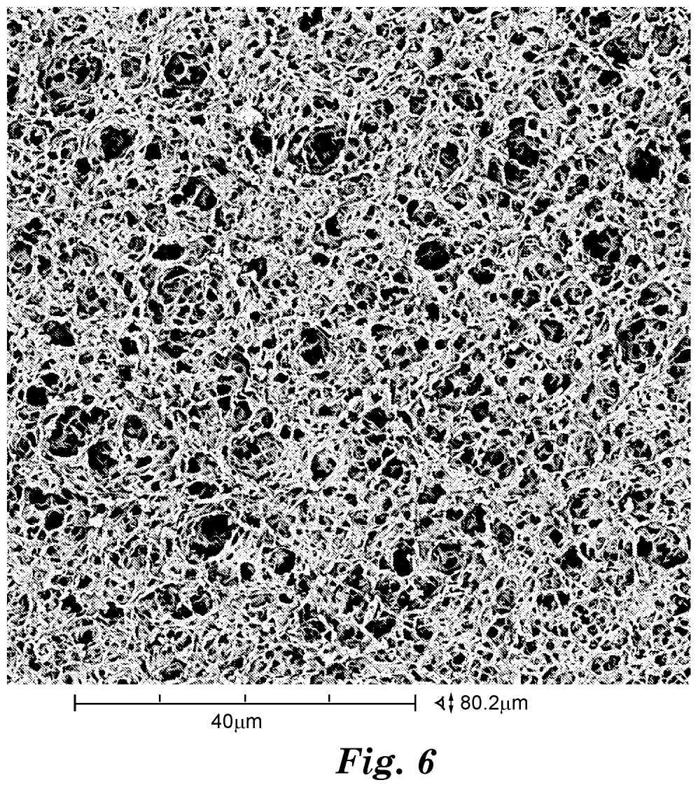

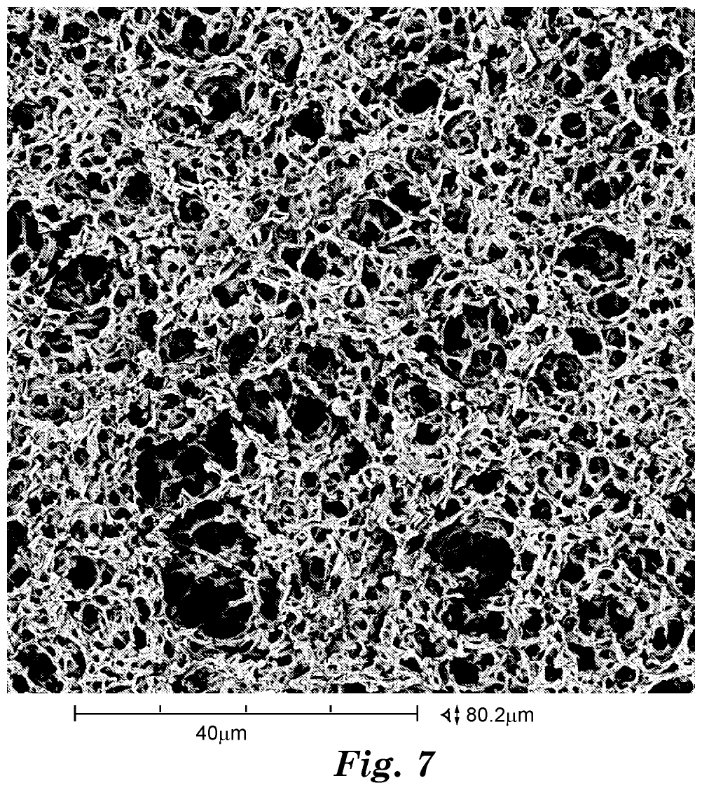

An asymmetric pore filled membrane was prepared using a microporous nylon substrate (BLA020, obtained from 3M Purification Inc., Meriden, Conn.). This porous substrate is described as having a tight/small surface on one side with an average pore size of 0.2 micrometer and an open/large surface on an opposite side with an average pore size of 0.65 micrometer. FIG. 6 is an SEM photomicrograph of the small pore surface of the membrane. FIG. 7 is an SEM photomicrograph of the large pore surface of the membrane.

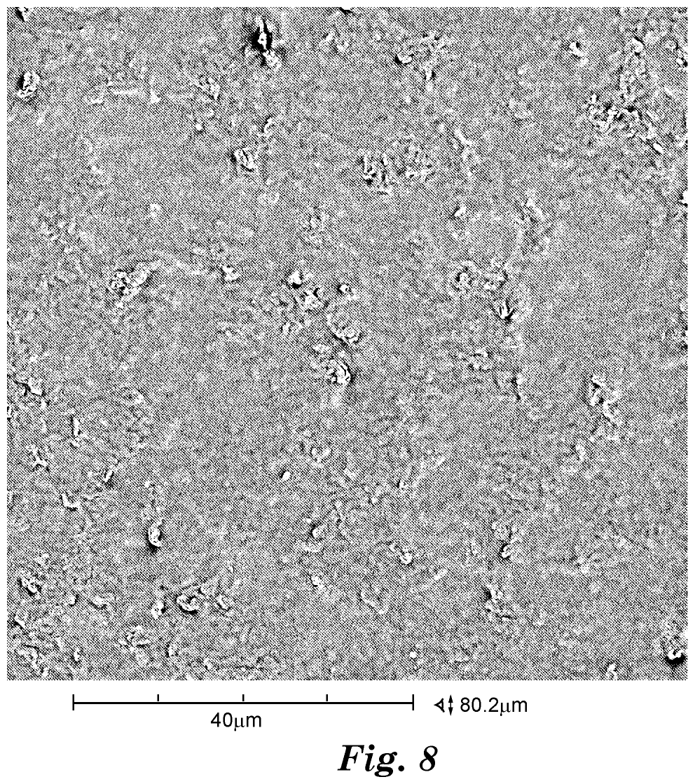

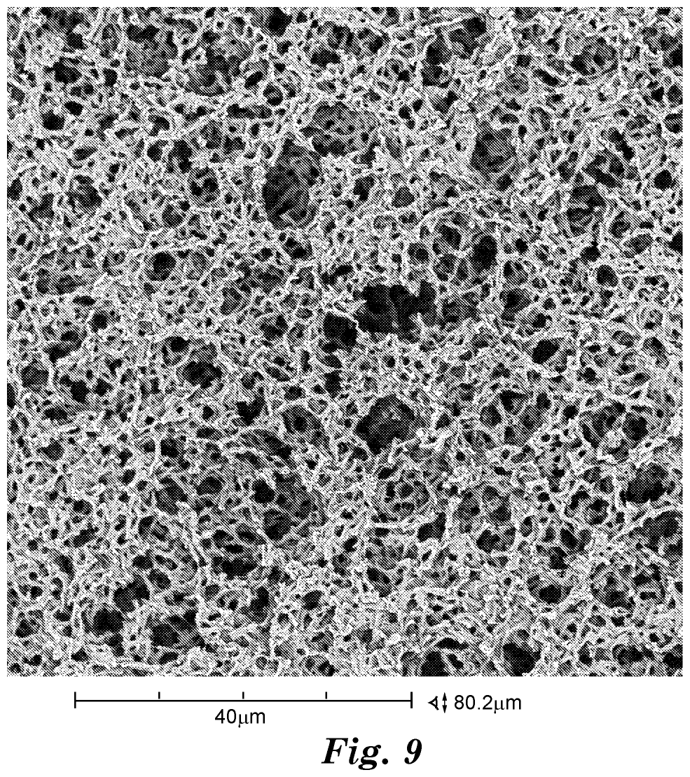

A pore-filling polymer solution was prepared by mixing 20.0 wt-% of polyethylene glycol 400 diacrylate (SR344, obtained from Sartomer, Exton, Pa.) into 80.0 wt-% deionized water. A BLA020 porous substrate (15 cm×25 cm) was placed into a polyethylene bag containing the pore-filling polymer solution to completely saturate and impregnate the porous substrate. The pore-filled substrate was removed from the bag and taped onto an aluminum panel (32 mm thick×38 cm width×51 cm length) with the tight/small pore side facing upwards. The panel was fed into an ultraviolet (UV) chamber on a moving belt running at a line speed of 6.1 meters/minute (m/min). The chamber was run with an inert nitrogen atmosphere and was equipped with a Fusion H lamp with an aluminum reflector as the UV source to polymerize and cross-link the SR344 acrylate. The UV cured pore-filled substrate was removed from the plate and washed with deionized water to remove any uncured polymer solution and then dried at room temperature. FIG. 8 is an SEM photomicrograph of the irradiated pore-filled small pore surface of the resulting composite membrane. FIG. 9 is an SEM photomicrograph of the non-irradiated large pore surface of the composite membrane.

The composite membrane was tested using Method 1 above except the gasoline feed temperature was maintained at approximately 27-31° C. at 20 Torr (2.67 kPa) vacuum and the results are reported in Table 1 below.

### Example 2

An asymmetric pore filled membrane was prepared as in Example 1 above. The resulting composite membrane was tested using Method 1 above except the gasoline feed temperature was maintained at approximately 21-22° C. at 20 Torr (2.67 kPa) vacuum and the results are reported in Table 1 below.

### Example 3

An asymmetric pore filled membrane was prepared as in Example 2 above except the pore-filling polymer solution was prepared by mixing 30.0 wt-% of polyethylene glycol 400 diacrylate (SR344), 2.0 wt-% titanium (IV) oxide (APS powder 32 nanometer particle size, obtained from Alfa Aesar, MA) into 68.0 wt-% deionized water with an ultrasonic bath for 30 minutes. The line speed into the UV chamber was set at 3.05 meters/minute (m/min). The resulting composite membrane was tested using Method 1 above except the gasoline feed temperature was maintained at approximately 21-22° C. at 20 Torr (2.67 kPa) vacuum and the results are reported in Table 1 below.

### Example 4

An asymmetric pore filled membrane was prepared as in Example 1 above except the pore-filling polymer solution was prepared by mixing 30 wt-% of polyethylene glycol 400 diacrylate (SR344) with NALCO 2326 (ammonia stabilized colloidal silica, 14.5% colloidal silica as SiO₂; particle size 5 nm; obtained from Nalco Chemical Company, Naperville, Ill.) in deionized water. The solution contained 30.0 wt-% SR344, 5.0 wt-% silica nanoparticles and 65.0 wt-% deionized water.

The line speed into the UV chamber was set at 12.2 m/min. The resulting composite membrane was tested using Method 1 above except the gasoline feed temperature was maintained at approximately 21-22° C. at 20 Torr (2.67 kPa) vacuum and the results are reported in Table 1 below.

### Example 5

An asymmetric pore filled membrane was prepared as in Example 1 above except the pore-filling polymer solution was prepared by mixing 30.0 wt-% of polyethylene glycol 400 diacrylate (SR344) with NALCO 2326 (ammonia stabilized colloidal silica, 14.5% colloidal silica as SiO₂; particle size 5 nm; obtained from Nalco Chemical Company, Naperville, Ill.) in deionized water. The solution contained 30.0 wt-% SR344, 10.0 wt-% silica nanoparticles and 60 wt-% deionized water.

The line speed into the UV chamber was set at 12.2 m/min. The resulting composite membrane was tested using Method 1 above except the gasoline feed temperature was maintained at approximately 21-22° C. at 20 Torr (2.67 kPa) vacuum and the results are reported in Table 1 below.

### Example 6A

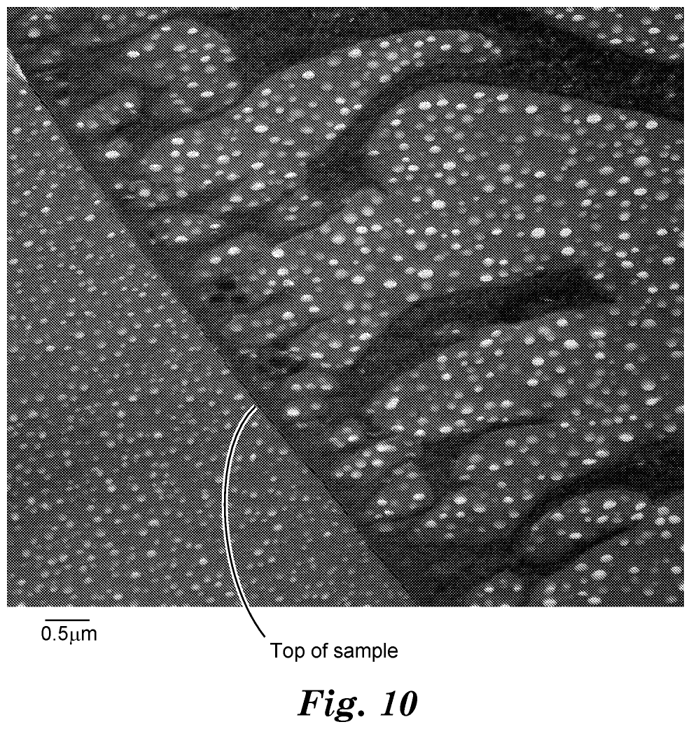

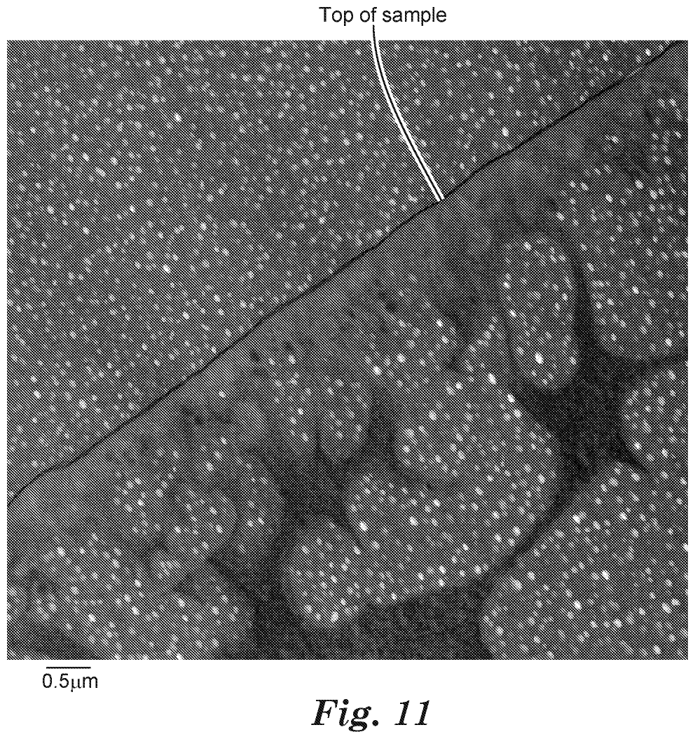

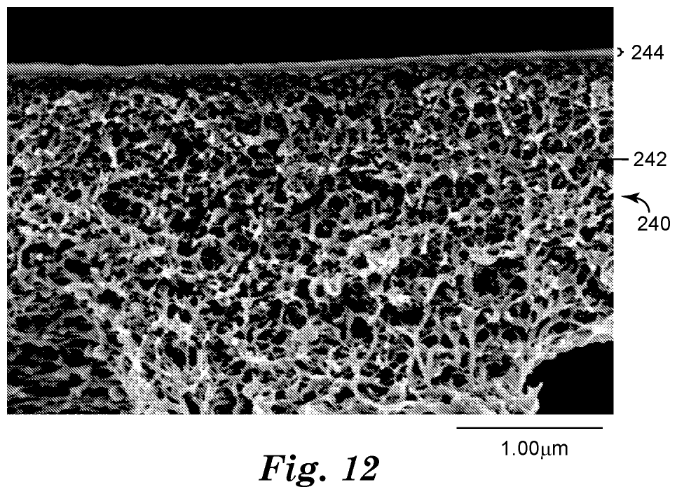

An asymmetric pore filled membrane was prepared as in Example 1 above except a polyethersulfone nanoporous substrate (PE900C/D) was used as the substrate. The pore-filling polymer solution was prepared by mixing 40 wt-% of SR344 into 60 wt-% deionized water. The line speed was set at 12.2 m/min. The resulting composite membrane was tested using Method 1 above except the gasoline feed temperature was maintained at approximately 21-22° C. at 20 Torr (2.67 kPa) vacuum and a feedstock flow rate of 300 mL/min. The results are reported in Table 1 below. FIGS. 10 and 11 are transmission electrophotomicrographs (TEM) of the cross-section of the nanoporous substrate (FIG. 10) and the resulting composite membrane (FIG. 11).

### Example 6B

An asymmetric pore filled membrane was prepared as in Example 6A above except the gasoline feed temperature was maintained at approximately 53° C. at 20 Torr (2.67 kPa) vacuum. The results are reported in Table 1 below.

### Example 7A

An asymmetric pore filled membrane was prepared as in Example 6A above except the line speed was set at 6.1 m/min. The results are reported in Table 1 below.

### Example 7B

An asymmetric pore filled membrane was prepared as in Example 6B above except the line speed was set at 6.1 m/min. The results are reported in Table 1 below.

### Example 8A

An asymmetric pore filled membrane was prepared as in Example 6A above except a polyacrylonitrile nanoporous substrate (PA450) was used as the substrate. The results are reported in Table 1 below.

### Example 8B

An asymmetric pore filled membrane was prepared as in Example 8A above except the gasoline feed temperature was maintained at approximately 53° C. at 20 Torr (2.67 kPa) vacuum. The results are reported in Table 1 below.

### Example 9

An asymmetric pore filled membrane was prepared as in Example 1 above except a polyethersulfone nanoporous substrate (PE2) was used as a substrate. The pore-filling solution was prepared by mixing 22.0 wt-% of polyethylene glycol 600 diacrylate (SR610, obtained from Sartomer, Exton, Pa.) in a 10.0 wt-% sodium chloride (NaCl) deionized water solution. A dichroic reflector was used in place of the aluminum reflector. The line speed was set at 6.1 m/min. The resulting composite membrane was tested using Method 1 (70° C.) above. The results are reported in Table 1 below.

### Example 10

An asymmetric pore filled membrane was prepared as in Example 9 above except the UV irradiation was carried out in a standard air atmosphere. There was approximately 20% oxygen in the atmosphere. The resulting composite membrane was tested using Method 1 (70° C.) above. The results are reported in Table 1 below.

### Example 11

An asymmetric pore filled membrane was prepared using a polyethersulfone nanoporous substrate (PE5) was used as a substrate. A silicone diacrylate (EBECRYL 350 (“EB350”) obtained from Cytec Industries, Smyrna, Ga.) was used as the pore-filling polymer. An excess amount of the EB350 was applied to the surface of the substrate and spread evenly using a rod. A 3 minute diffusion time was allowed before blotting the excessive surface solution using a paper towel. UV irradiation of the pore-filled substrate was performed as in Example 1 except a dichroic reflector was used. The line speed was set at 6.1 m/min. The UV cured pore-filled substrate was washed in ethanol to remove any uncured polymer solution and then dried and tested using Method 1 above except the gasoline feed temperature was maintained at approximately 50° C. The results are reported in Table 1 below.

### Example 12

An asymmetric pore filled membrane was prepared as in Example 11 above except the pore-filling solution was prepared by mixing 10.0 wt-% of a triacrylate (SR454, ethoxylated 3-trimethylolpropane triacrylate, obtained from Sartomer, Exton, Pa.) with 90.0 wt-% of EB350. The UV cured pore-filled substrate was washed in ethanol to remove any uncured polymer solution and then dried and tested using Method 1 (50° C.) above with the results reported in Table 1 below. The resulting composite membrane was also tested using Method 2 above with the results reported in Table 2 below.

### Example 13

An asymmetric pore filled membrane was prepared as in Example 11 above except the pore-filling solution was prepared by mixing 20.0 wt-% of trimethylolpropane triacrylate (TMPTA, obtained from Alfa Aesar, Ward Hill, Mass.) with 80.0 wt-% of EB350. The UV cured pore-filled substrate was washed in ethanol to remove any uncured polymer solution and then dried and tested using Method 1 (50° C.) above with the results reported in Table 1 below. The resulting composite membrane was also tested using Method 2 above with the results reported in Table 2 below.

### Example 14

An asymmetric pore filled membrane was prepared as in Example 11 above except the pore-filling solution was prepared by mixing 20.0 wt-% of polyethylene glycol 200 diacrylate (SR259, obtained from Sartomer, Exton, Pa.) with 80.0 wt-% of EB350. The UV cured pore-filled substrate was washed in ethanol to remove any uncured polymer solution and then dried and tested using Method 1 (50° C.) above with the results reported in Table 1 below.

### Example 15

An asymmetric pore filled membrane was prepared as in Example 11 above except the pore-filling solution was prepared by mixing 20.0 wt-% of SR344 with 80.0 wt-% of EB350. The UV cured pore-filled substrate was washed in ethanol to remove any uncured polymer solution and then dried and tested using Method 1 (50° C.) above with the results reported in Table 1 below.

### Example 16

An asymmetric pore filled membrane was prepared as in Example 11 above except the pore-filling solution was prepared by mixing 20.0 wt-% of SR610 with 80.0 wt-% of EB350. The UV cured pore-filled substrate was washed in ethanol to remove any uncured polymer solution and then dried and tested using Method 1 (50° C.) above with the results reported in Table 1 below.

### Example 17

An asymmetric pore filled membrane was prepared as in Example 11 above except the pore-filling solution was prepared by mixing 30.0 wt-% of glycerol triacetate (GTA, obtained from Univar USA, Redmond, Wash.) with 70.0 wt-% of a blend of TMPTA (20.0 wt-%) and EB350 (80.0 wt-%). The UV cured pore-filled substrate was washed in ethanol to remove any uncured polymer solution and then dried and tested using Method 1 (50° C.) above with the results reported in Table 1 below.

### Example 18

An asymmetric pore filled membrane was prepared as in Example 11 above except the pore-filling solution was prepared by mixing 30.0 wt-% of GTA with 70.0 wt-% of a blend of SR259 (20.0%) and EB350 (80.0%). The UV cured pore-filled substrate was washed in ethanol to remove any uncured polymer solution and then dried and tested using Method 1 (50° C.) above with the results reported in Table 1 below.

### Example 19

An asymmetric pore filled membrane was prepared as in Example 11 above except the pore-filling solution was prepared by mixing 50.0 wt-% of GTA with 50.0 wt-% of a blend of SR259 (20%) and EBACRYL E350 (80%). The UV cured pore-filled substrate was washed in ethanol to remove any uncured polymer solution and then dried and tested using Method 1 (50° C.) above with the results reported in Table 1 below.

### Example 20

An asymmetric pore filled membrane was prepared as in Example 11 above except the pore-filling solution was prepared by mixing 50.0 wt-% of dibutyl sebacate (DBS obtained from Vertellus Performance Materials, Inc., Greensboro, N.C.) with 50.0 wt-% of EB350. The UV cured pore-filled substrate was washed in ethanol to remove any uncured polymer solution and then dried and tested using Method 1 (50° C.) above with the results reported in Table 1 below.

### Example 21

An asymmetric pore filled membrane was prepared as in Example 1 above except polyethersulfone nanoporous substrate (PE2) was used as the substrate. The pore-filling polymer solution was prepared by mixing 40.0 wt-% of polyethylene glycol 400 dimethacrylate (SR6030P obtained from Sartomer, Exton, Pa.) with 60.0 wt-% of deionized water. A dichroic reflector was used in place of the aluminum reflector. The line speed was set at 12.2 m/min. The UV cured pore-filled substrate was washed in deionized water to remove any uncured polymer solution and then dried and tested using Method 1 (70° C.) above with the results reported in Table 1 below.

### Example 22

An asymmetric pore filled membrane was prepared as in Example 21 above except the pore-filling solution was prepared by mixing 40.0 wt-% of SR6030P with 60.0 wt-% of DBS. The line speed was set at 12.2 m/min. The UV cured pore-filled substrate e was washed in ethanol to remove any uncured polymer solution and then dried and tested using Method 1 (70° C.) above with the results reported in Table 1 below.

### Example 23

An asymmetric pore filled membrane was prepared as in Example 22 above except the pore-filling solution was prepared by mixing 40.0 wt-% of methoxy polyethylene glycol 550 monoacrylate (CD553, obtained from Sartomer, Exton, Pa.) with 60.0 wt-% of DBS. The line speed was set at 12.2 m/min. An aluminum reflector was used in the UV chamber. The UV cured pore-filled substrate was washed in ethanol to remove any uncured polymer solution and then dried and tested using Method 1 (70° C.) above with the results reported in Table 1 below. FIG. 12 is an SEM photomicrograph of the cross-section of the irradiated pore-filled resulting composite membrane. The thickness of the top, irradiated/cured layer was measured to be approximately 200 nanometers.

### Example 24

An asymmetric pore filled membrane was prepared as in Example 23 above except the pore-filling solution was prepared by mixing 40.0 wt-% of methoxy polyethylene glycol 550 monoacrylate (CD552, obtained from Sartomer, Exton, Pa.) with 60.0 wt-% of DBS. The UV cured pore-filled substrate was washed in ethanol to remove any uncured polymer solution and then dried and tested using Method 1 (70° C.) above with the results reported in Table 1 below.

### Example 25

An asymmetric pore filled membrane was prepared as in Example 21 above except a polyethersulfone nanoporous substrate (PE5) was used as the substrate. The pore-filling solution was prepared by mixing 40.0 wt-% of 2-hydroxyl methacrylate (HEMA, obtained from Alfa Aesar, Ward Hill, Mass.) with 60.0 wt-% of deionized water. The line speed was set at 6.1 m/min. A dichroic reflector was used. The UV cured pore-filled substrate was washed in ethanol to remove any uncured polymer solution and then dried and tested using Method 1 (50° C.) above with the results reported in Table 1 below.

### Example 26

An asymmetric pore filled membrane was prepared as in Example 25 above except the pore-filling solution was prepared by mixing 20.0 wt-% of SR344 with 80.0 wt-% of deionized water. A polyethersulfone nanoporous substrate (PE5) was used as the substrate. The UV cured pore-filled substrate was washed in ethanol to remove any uncured polymer solution and then dried and tested using Method 1 (50° C.) above with the results reported in Table 1 below.

### Example 27

An asymmetric pore filled membrane was prepared as in Example 26 above except the pore-filling solution was prepared by mixing 20.0 wt-% of SR344 with 79.9 wt-% of deionized water. 0.1 wt-% a photoinitiator (1-[4-(2-Hydroxyethoxy)-phenyl]-2-hydroxy-2-methyl-1-propane-1-one, IRGACURE® 2959, obtained from BASF Corp., Florham Park, N.J.) was added to the polymer solution. The UV cured pore-filled substrate was washed in ethanol to remove any uncured polymer solution and then dried and tested using Method 1 (50° C.) above with the results reported in Table 1 below.

### Example 28

An asymmetric pore filled membrane was prepared as in Example 11 above except the pore-filling solution was prepared by mixing 10.0 wt-% of SR454 with 90.0 wt-% of GTA. A 3 minute diffusion time was allowed before blotting the excessive surface solution using a paper towel. UV irradiation of the pore-filled substrate was performed as in Example 11. The UV cured pore-filled substrate was washed in ethanol to remove any uncured polymer solution and then dried and tested using Method 1 (50° C.) above with the results reported in Table 1 below.

### Example 29

An asymmetric pore filled membrane was prepared as in Example 28 above except the pore-filling solution was prepared by mixing 10.0 wt-% of 1H,1H,6H,6H-perflourohexyldiacrylate (FHDA, obtained from Oakwood Products, West Columbia, S.C.) with 90.0 wt-% of GTA. A one minute diffusion time was allowed before blotting the excessive surface solution using a paper towel before UV irradiation. The line speed was set at 6.1 m/min. A dichroic reflector was used. The UV cured pore-filled substrate was washed in ethanol to remove any uncured polymer solution and then dried and tested using Method 1 (50° C.) above with the results reported in Table 1 below.

### Example 30

An asymmetric pore filled membrane was prepared as in Example 29 above except the pore-filling solution was prepared by mixing 50.0 wt-% of FHDA with 50.0 wt-% of GTA. The UV cured pore-filled substrate was washed in ethanol to remove any uncured polymer solution and then dried and tested using Method 1 (50° C.) above with the results reported in Table 1 below.

### Example 31

An asymmetric pore filled membrane was prepared as in Example 29 above except the pore-filling solution was prepared by mixing 80.0 wt-% of polypropylene glycol 900 diacrylate (PPG900DA, obtained from Sigma Aldrich, Milwaukee, Wis.) with 20.0 wt-% of GTA. The UV cured pore-filled substrate was washed in ethanol to remove any uncured polymer solution and then dried and tested using Method 1 (50° C.) above with the results reported in Table 1 below.

### Example 32

An asymmetric pore filled membrane was prepared as in Example 31 above except the pore-filling solution was prepared by mixing 80.0 wt-% PPG900DA with 20.0 wt-% of SR344. The UV cured pore-filled substrate was washed in ethanol to remove any uncured polymer solution and then dried and tested using Method 1 (50° C.) above with the results reported in Table 1 below.

### Example 33

An asymmetric pore filled membrane was prepared as in Example 25 above except the pore-filling solution was prepared by mixing 20.0 wt-% SR610 with 80.0 wt-% of deionized water. The UV cured pore-filled substrate was washed in deionized water to remove any uncured polymer solution and then dried and tested using Method 1 (50° C.) above with the results reported in Table 1 below.

### Example 34

An asymmetric pore filled membrane was prepared as in Example 33 above except the pore-filling solution was prepared by mixing 20.0 wt-% SR610 with 78.0 wt-% of deionized water and 2.0 wt-% sodium chloride (NaCl). The UV cured pore-filled substrate was washed in deionized water to remove any uncured polymer solution and then dried and tested using Method 1 (50° C.) above with the results reported in Table 1 below.

### Example 35

An asymmetric pore filled membrane was prepared as in Example 34 above except the pore-filling solution was prepared by mixing 20.0 wt-% SR610 with 77.8 wt-% of deionized water and 2.0 wt-% sodium chloride (NaCl) and 0.2 wt-% N,N′-methylenebisacrylamide (BIS, obtained from Alfa Aesar, Ward Hill, Mass.). The UV cured pore-filled substrate was washed in deionized water to remove any uncured polymer solution and then dried and tested using Method 1 (50° C.) above with the results reported in Table 1 below.

### Example 36

An asymmetric pore filled membrane was prepared as in Example 34 above except the pore-filling solution was prepared by mixing 15.0 wt-% SR610 with 78.4 wt-% of deionized water and 6.0% NaCl and 0.6 wt-% BIS. The UV cured pore-filled substrate was washed in deionized water to remove any uncured polymer solution and then dried and tested using Method 1 (50° C.) above with the results reported in Table 1 below. The resulting composite membrane was also tested using Method 2 (70° C.) above with the results reported in Table 2 below.

### Example 37

An asymmetric pore filled membrane was prepared as in Example 34 above except the pore-filling solution was prepared by mixing 15.0 wt-% SR415 (ethoxylated trimethylolpropane triacrylate, obtained from Sartomer, Exton, Pa.) with 78.4 wt-% of deionized water and 6% NaCl and 0.6 wt-% BIS. The UV cured pore-filled substrate was washed in deionized water to remove any uncured polymer solution and then dried and tested using Method 1 (50° C.) above with the results reported in Table 1 below.

### Example 38

An asymmetric pore filled membrane was prepared as in Example 34 above except the pore-filling solution was prepared by mixing 10.0 wt-% polyethylene glycol methylether methacrylate (PEGMMA, Mn-2080, obtained from Sigma Aldrich, Milwaukee, Wis.) with 89.2 wt-% of deionized water and 0.8 wt-% BIS. The UV cured pore-filled substrate was washed in deionized water to remove any uncured polymer solution and then dried and tested using Method 1 (50° C.) above with the results reported in Table 1 below.

### Example 39

An asymmetric pore filled membrane was prepared as in Example 33 above except the pore-filling solution was prepared by mixing 20.0 wt-% polyester acrylate (CN2622, obtained from Sartomer Co., Exton, Pa.) with 80.0 wt-% GTA. The UV cured pore-filled substrate was washed in ethanol to remove any uncured polymer solution and then dried and tested using Method 1 (70° C.) above with the results reported in Table 1 below.

### Example 40

An asymmetric pore filled membrane was prepared as in Example 38 above except the pore-filling solution was prepared by mixing 20.0 wt-% SR610 with 77.4 wt-% deionized water and 2.5 wt-% 2-acrylamido-2-methylpropanesulfonic acid (AMPS, obtained from Sigma Aldrich, Milwaukee, Wis.) and 0.1 wt-% IRGACURE 2959. A polyethersulfone nanoporous substrate (PE2) was used as the substrate. The line speed was set at 12.2 m/min. The UV irradiation was performed in a standard air atmosphere. The UV cured pore-filled substrate was washed in deionized water to remove any uncured polymer solution and then dried and tested using Method 1 (70° C.) above with the results reported in Table 1 below.

### Example 41

An asymmetric pore filled membrane was prepared as in Example 40 above except the pore-filling solution was prepared by mixing 20.0 wt-% SR610 with 77.5 wt-% deionized water and 2.5 wt-% AMPS. The UV cured pore-filled substrate was washed in deionized water to remove any uncured polymer solution and then dried and tested using Method 1 (70° C.) above with the results reported in Table 1 below.

### Example 42

An asymmetric pore filled membrane was prepared as in Example 40 above except the pore-filling solution was prepared by mixing 10 wt-% SR610 with 84.5 wt-% deionized water and 5.0 wt-% AMPS and 0.1 wt-% IRGACURE 2959. The line speed was 18.3 m/min. The UV cured pore-filled substrate was washed in ethanol to remove any uncured polymer solution and then dried and tested using Method 1 (70° C.) above with the results reported in Table 1 below.

### Example 43

An asymmetric pore filled membrane was prepared as in Example 40 above except the pore-filling solution was prepared by mixing 20.0 wt-% SR610 with 75.0 wt-% deionized water and 5.0 wt-% AMPS. The UV cured pore-filled substrate was washed in deionized water to remove any uncured polymer solution and then dried and tested using Method 1 (70° C.) above with the results reported in Table 1 below.

### Example 44

An asymmetric pore filled membrane was prepared as in Example 40 above except the pore-filling solution was prepared by mixing 5.0 wt-% SR344 with 90.0 wt-% deionized water and 5.0 wt-% AMPS. The line speed was 6.1 m/min. The UV cured pore-filled substrate was washed in deionized water to remove any uncured polymer solution and then dried and tested using Method 1 (70° C.) above with the results reported in Table 1 below.

### Example 45

An asymmetric pore filled membrane was prepared using a polyethersulfone nanoporous substrate (PE5) was used a substrate. A pore-filling solution was prepared by mixing 60.0 wt-% of SR415 (obtained from Sartomer, Exton, Pa.) and 40.0 wt-% deionized water. An excess amount of the solution above was applied to the surface of the substrate and spread evening using a Mayer rod #8. A 1 min diffusion time was allowed before blotting the excessive surface solution using a paper towel. UV irradiation of the pore-filled substrate was performed as in Example 1. The line speed was set at 12.2 m/min. The UV cured pore-filled substrate was washed in deionized water at 50° C. for at least 2 hours and then dried and tested using method 1 at 70° C. feedstock temperature. The results are reported in Table 1.

### Example 46

An asymmetric pore filled membrane was prepared as in Example 45 above except the pore-filling solution was prepared by mixing 60.0 wt-% SR415, 5.0 wt-% polyacrylic acid (weight average molecular weight (MW) approximately 1800, obtained from Alfa Aesar, Ward Hill, Mass.) and 35.0 wt-% deionized water. The UV cured pore-filled substrate was washed in deionized water at 50° C. for at least 2 hours and then dried and tested using method 1 at 70° C. feedstock temperature with the results reported in Table 1. In the presence of polyacrylic acid, both permeate ethanol concentration and ethanol mass flux increased.

### Example 47

An asymmetric pore filled membrane was prepared as in Example 45 above except the pore-filling solution was prepared by mixing 60.0 wt-% SR610, and 40.0 wt-% deionized water. The UV cured pore-filled substrate was washed in deionized water at 50° C. for at least 2 hours and then dried and tested using method 1 at 70° C. feedstock temperature with the results reported in Table 1.

### Example 48

An asymmetric pore filled membrane was prepared as in Example 45 above except the pore-filling solution was prepared by mixing 60.0 wt-% SR610, 5.0 wt-% polyacrylic acid (weight average MW approximately 1800) and 35.0 wt-% deionized water. The UV cured pore-filled substrate was washed in deionized water at 50° C. for at least 2 hours and then dried and tested using method 1 at 70° C. feedstock temperature with the results reported in Table 1. In the presence of polyacrylic acid, again both permeate ethanol concentration and ethanol mass flux increased.

### Example 49

An asymmetric pore filled membrane was prepared as in Example 45 above except the pore-filling solution was prepared by mixing 60.0 wt-% SR610, 5.0 wt-% polyacrylic acid (weight average MW approximately 5000, obtained from Alfa Aesar, Ward Hill, Mass.) and 35.0 wt-% deionized water. The UV cured pore-filled substrate was washed in deionized water at 50° C. for at least 2 hours and then dried and tested using method 1 at 70° C. feedstock temperature with the results reported in Table 1.

TABLE 1

| | | Feed | Permeate | |
|---|---|---|---|---|
| | Total | ethanol | ethanol | Ethanol |
| Example | Mass Flux | concen- | concen- | Mass Flux |
| # | (kg/m²/h) | tration | tration | (kg/m²/h) |
| 1 | 5.49 | 9.3% | 34.1% | 1.87 |
| 2 | 1.85 | 8.0% | 39.3% | 0.73 |
| 3 | 0.55 | 8.9% | 50.3% | 0.28 |
| 4 | 1.45 | 9.5% | 43.5% | 0.63 |
| 5 | 1.15 | 10.7% | 49.5% | 0.57 |
| 6A | 1.39 | 8.6% | 59.6% | 0.83 |
| 6B | 5.59 | 9.3% | 66.6% | 3.72 |
| 7A | 0.73 | 11.2% | 75.5% | 0.55 |
| 7B | 3.08 | 9.2% | 78.4% | 2.41 |
| 8A | 2.03 | 9.0% | 54.9% | 1.11 |
| 8B | 6.43 | 9.7% | 49.9% | 3.21 |
| 9 | 9.10 | 9.0% | 57.7% | 5.25 |
| 10 | 5.84 | 7.2% | 68.3% | 3.99 |
| 11 | 6.64 | 7.6% | 42.1% | 2.80 |
| 12 | 4.47 | 7.7% | 57.0% | 2.55 |
| 13 | 2.78 | 8.8% | 65.1% | 1.81 |
| 14 | 0.65 | 9.4% | 95.2% | 0.62 |
| 15 | 0.51 | 7.4% | 84.4% | 0.43 |
| 16 | 0.89 | 9.5% | 94.6% | 0.84 |
| 17 | 3.60 | 9.9% | 60.0% | 2.16 |
| 18 | 0.86 | 8.7% | 89.5% | 0.77 |
| 19 | 2.63 | 9.1% | 63.6% | 1.67 |
| 20 | 5.38 | 10.6% | 62.6% | 3.37 |
| 21 | 6.79 | 7.7% | 52.6% | 3.57 |
| 22 | 8.10 | 7.4% | 62.9% | 5.09 |
| 23 | 11.14 | 7.5% | 39.6% | 4.41 |
| 24 | 6.28 | 7.8% | 50.0% | 3.14 |
| 25 | 1.90 | 8.5% | 39.8% | 0.76 |
| 26 | 7.24 | 9.1% | 58.4% | 4.23 |
| 27 | 5.31 | 9.8% | 55.8% | 2.96 |
| 28 | 0.80 | 8.6% | 82.2% | 0.66 |
| 29 | 1.37 | 9.2% | 77.8% | 1.07 |
| 30 | 0.51 | 9.7% | 93.3% | 0.48 |
| 31 | 19.74 | 8.3% | 23.7% | 4.68 |
| 32 | 1.32 | 8.4% | 82.5% | 1.09 |
| 33 | 5.36 | 7.8% | 63.1% | 3.38 |
| 34 | 7.42 | 9.1% | 61.0% | 4.53 |
| 35 | 5.75 | 9.3% | 64.6% | 3.71 |
| 36 | 4.48 | 9.5% | 70.0% | 3.14 |
| 37 | 3.80 | 9.7% | 71.6% | 2.72 |
| 38 | 0.92 | 8.8% | 74.5% | 0.69 |
| 39 | 4.10 | 7.3% | 63.9% | 2.62 |
| 40 | 11.93 | 9.3% | 51.4% | 6.13 |
| 41 | 6.13 | 8.7% | 65.4% | 4.01 |
| 42 | 3.50 | 8.1% | 74.6% | 2.61 |
| 43 | 5.43 | 8.5% | 71.2% | 3.87 |
| 44 | 1.88 | 8.1% | 78.6% | 1.48 |
| 45 | 4.40 | 9.2% | 55.9% | 2.48 |
| 46 | 4.60 | 9.0% | 59.1% | 2.70 |
| 47 | 3.90 | 8.9% | 62.6% | 2.41 |
| 48 | 4.29 | 8.9% | 69.7% | 2.99 |
| 49 | 4.70 | 9.2% | 68.0% | 3.20 |

TABLE 2

| | | Permeate | |
|---|---|---|---|
| | Total | ethanol | Average ethanol |
| Example | Mass Flux | concen- | mass flux |
| # | (kg/m²/h) | tration | (kg/m²/h) |
| 12 | 6.79 | 45.2% | 3.07 |
| 13 | 3.36 | 57.2% | 1.93 |
| 36 | 4.46 | 59.6% | 2.66 |

Each of Examples 1 through 49 may be modified according to the present disclosure to further include at least one of: (a) a liquid ionic compound mixed with the pore-filling polymer; or (b) an amorphous fluorochemical film disposed on the composite membrane so as to protect the pore filling polymer. Examples of this are in the following examples.

### Comparative Example 50

A coating solution was prepared by mixing 40 wt-% SR344 and 60 wt-% DBS. The coating solution saturated a PE2 substrate using a dip-coater in a pilot line. The saturated PE2 substrate passed through a nip roll to remove the excessive surface solution before UV irradiation by Fusion UV system equipped with H bulb and aluminum reflector at the line speed 7.65 meters/min. UV chamber was kept inert by nitrogen purging and the oxygen level maintained at 7 ppm. The irradiated membrane was washed by soaking in EtOH to remove any uncured polymer solution and then dried and tested using Method 3 above with the results reported in Table 3 below, and using Method 4 above with the results reported in Table 4 below.

### Example 51

A coating solution was prepared by mixing 0.3 wt-% AF2400 and 99.7 wt-% HFE7200. The coating solution was applied on top of an asymmetric pore-filled membrane prepared above in Comparative Example 50 using a Mayer rod #5 (RD Specialties, Inc., Webster, N.Y.). The solvent HFE7200 was allowed to evaporate at room temperature at least 2 hours and the membrane was tested using Method 3 above with the results reported in Table 3 below, and using Method 4 above with the results reported in Table 4 below.

### Example 52

A coating solution was prepared by mixing 5.0 wt-% EMIM-Tf₂N and 95.0 wt-% a solvent mixture (70.0 wt-% EtOH and 30 wt-% de-ionized H₂O). The coating solution was applied on top of an asymmetric pore filled membrane prepared above in Comparative Example 50 using a Mayer rod #5. The solvent was allowed to evaporate at room temperature for at least 2 hours. No visual ionic liquid EMIM-Tf₂N deposition was observed at the membrane surface which indicates ionic liquid diffused into the pore filling materials. The membrane was tested using Method 3 above with the results reported in Table 3 below, and using Method 4 above with the results reported in Table 4 below.

### Comparative Example 53

An asymmetric pore-filled membrane was prepared as in Comparative Example 50 above except the pore-filling solution was prepared by mixing 40.0 wt-% SR6030P and 60.0 wt-% DBS and UV irradiation line speed was 12.28 meters/min. The irradiated membrane was washed by soaking in EtOH to remove any uncured polymer solution and then dried and tested using Method 3 above with the results reported in Table 3.

### Example 54

A coating solution was prepared by mixing 0.3 wt-% AF2400 and 99.7 wt-% HFE7200. The coating solution was applied on top of an asymmetric pore-filled membrane prepared above in Comparative Example 53 using a Mayer rod #5 (RD Specialties, Inc., Webster, N.Y.). The solvent HFE7200 was allowed to evaporate at room temperature for at least 2 hours and the membrane was tested using Method 3 above with the results reported in Table 3 below.

### Example 55

A coating solution was prepared by mixing 5.0 wt-% EMIM-TFSA and 95.0 wt-% a solvent mixture (70.0 wt-% EtOH and 30 wt-% de-ionized H₂O). The coating solution was applied on top of an asymmetric pore filled membrane prepared above in Comparative Example 53 using a Mayer rod #5. The solvent was allowed to evaporate for at least 2 hours. No visual ionic liquid EMIM-TFSA deposition was observed at the membrane surface, and the membrane was tested using Method 3 above with the results reported in Table 3 below.

TABLE 3

| | | Feed | Permeate | |
|---|---|---|---|---|
| | Total | ethanol | ethanol | Ethanol |
| Example | Mass Flux | concen- | concen- | Mass Flux |
| # | (kg/m²/h) | tration | tration | (kg/m²/h) |
| Compar- | 2.57 | 9.2% | 80.8% +/− 1.4% | 2.08 +/− 0.33 |
| ative 50 | | | | |
| 51 | 2.57 | 9.3% | 84.2% +/− 3.2% | 2.16 +/− 0.30 |
| 52 | 2.71 | 9.2% | 81.6% +/− 0.6% | 2.21 +/− 0.19 |
| Compar- | 6.29 | 7.4% | 57.1% +/− 1.3% | 3.59 +/− 0.10 |
| ative 53 | | | | |
| 54 | 5.29 | 8.0% | 63.5% +/− 1.4% | 3.35 +/− 0.35 |
| 55 | 5.14 | — | 61.0% +/− 0.92 | 3.27 +/− 0.14 |

TABLE 4

| | | | Permeate | Permeate | Total fluxes |
|---|---|---|---|---|---|
| | Total | Permeate | aromatics | overall | (EtOH + |
| Example | Mass Flux | EtOH | excluding | (EtOH + | aromatics) |
| # | (kg/m²/h) | Conc. | EtOH | aromatics) | (kg/m²/ h) |
| Compar- | 2.14 | 66.4% | 45.5% | 81.7% | 1.75 |
| ative 50 | | | | | |
| 51 | 3.00 | 67.4% | 49.5% | 83.5% | 2.51 |
| 52 | 2.86 | 67.8% | 46.6% | 82.8% | 2.37 |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. An asymmetric composite membrane for selectively pervaporating a high octane compound from a feed mixture comprising the high octane compound and gasoline, the asymmetric composite membrane comprising:
a porous substrate comprising opposite first and second major surfaces, and a plurality of pores; and
a pore-filling polymer disposed in at least some of the pores so as to form a layer having a thickness within the porous substrate, with the amount of the pore-filling polymer at, or adjacent to, the first major surface being greater than the amount of the pore-filling polymer at, or adjacent to, the second major surface;
wherein the pore-filling polymer is more permeable to the high octane compound than gasoline;
wherein the composite membrane further comprises at least one of:
(a) a liquid ionic compound mixed with the pore-filling polymer; or
(b) an amorphous fluorochemical film disposed on the composite membrane.

2. The composite membrane according to claim 1, wherein the high octane compound is an alcohol.

3. The composite membrane according to claim 1 further comprising an amorphous fluorochemical film.

4. The composite membrane according to claim 3 wherein the amorphous fluorochemical film is a plasma-deposited fluorochemical film.

5. The composite membrane according to claim 4 wherein the plasma-deposited fluorochemical film is derived from one or more fluorinated compounds selected from:
linear, branched, or cyclic saturated perfluorocarbons;
linear, branched, or cyclic unsaturated perfluorocarbons;
linear, branched, or cyclic saturated partially fluorinated hydrocarbons;
linear, branched, or cyclic unsaturated partially fluorinated hydrocarbons;
carbonylfluorides;
perfluorohypofluorides;
perfluoroether compounds;
oxygen-containing fluorides;
halogen fluorides;
sulfur-containing fluorides;
nitrogen-containing fluorides;
silicon-containing fluorides;
inorganic fluorides; and
rare gas-containing fluorides.

6. The composite membrane according to claim 5 wherein the plasma-deposited fluorochemical film is derived from one or more fluorinated compounds selected from CF₄, SF₆, C₂F₆, C₃F₈, C₄F₁₀, C₅F₁₂, C₆F₁₄, C₇F₁₆, C₈F₁₈, C₂F₄, C₃F₆, C₄F₈, C₅F₁₀, C₆F₁₂, C₄F₆, C₇F₁₄, C₈F₁₆, CF₃COF, CF₂(COF)₂, C₃F₇COF, CF₃OF, C₂F₅OF, CF₃COOF, CF₃OCF₃, C₂F₅OC₂F₅, C₂F₄OC₂F₄, OF₂, SOF₂, SOF₄, NOF, ClF₃, IF₅, BrF₅, BrF₃, CF₃I, C₂F₅I, N₂F₄, NF₃, NOF₃, SiF₄, SiF₄, Si₂F₆, XeF₂, XeF₄, KrF₂, SF₄, SF₆, monofluorobenzene, 1,2-difluorobenzene, 1,2,4-trifluorobenzene, pentafluorobenzene, pentafluoropyridine, and pentafluorotolenene.

7. The composite membrane according claim 3 wherein the plasma-deposited fluorochemical film is derived from one or more hydrocarbon compounds in combination with one or more fluorinated compounds.

8. The composite membrane according to claim 3 wherein the amorphous fluorochemical film comprises an amorphous glassy perfluoropolymer having a Tg of at least 100° C.

9. The composite membrane according to claim 1 further comprising one or more liquid ionic compounds.

10. The composite membrane according to claim 9 wherein the one or more liquid ionic compounds comprise one or more cations selected from imidazolium, pyrazolium, oxazolium, thiazolium, triazolium, pyridinium, pyridazinium, pyrimidinium, and pyrazinium.

11. The composite membrane according to claim 10 wherein the one or more liquid ionic compounds comprise one or more anions selected from Cl⁻, Br⁻, I⁻, HSO₄⁻, NO₃⁻, SO₄²⁻, CH₃SO₃⁻, N(SO₂CF₃)₂—, CF₃SO₃⁻, B(CN)₄⁻, C₄F₉SO₃⁻, PF₆⁻, N(CN)₄⁻, c(CN)₄⁻, BF₄⁻, Ac⁻, SCN⁻, HSO₄⁻, CH₃SO₄⁻, C₂H₅SO₄⁻, and C₄H₉SO₄⁻.

12. The composite membrane according to claim 11 wherein the one or more liquid ionic compounds are selected from 1-ethyl-3-methyl imidazolium tetrafluoroborate (Emim-BF₄), 1-ethyl-3-methyl imidazolium trifluoromethane sulfonate (Emim-TFSA), 3-methyl-N-butyl-pyridinium tetrafluoroborate, 3-methyl-N-butyl-pyridinium trifluoromethanesulfonate, N-butyl-pyridinium tetrafluoroborate, 1-butyl-2,3-dimethylimidazolium tetrafluoroborate, 1-butyl-2,3-dimethylimidazolium trifluoromethanesulfonate, 1-ethyl-3-methylimidazolium chloride, 1-butyl-3-ethylimidazolium chloride, 1-butyl-3-methylimidazolium chloride, 1-butyl-3-methylimidazolium bromide, 1-methyl-3-propylimidazolium chloride, 1-methyl-3-hexylimidazolium chloride, 1-methyl-3-octylimidazolium chloride, 1-methyl-3-decylimidazolium chloride, 1-methyl-3-dodecylimidazolium chloride, 1-methyl-3-hexadecylimidazolium chloride, 1-methyl-3-octadecylimidazolium chloride, 1-ethylpyridinium bromide, 1-ethylpyridinium chloride, 1-butylpyridinium chloride, and 1-benzylpyridinium bromide, 1-butyl-3-methylimidazolium iodide, 1-butyl-3-methylimidazolium nitrate, 1-ethyl-3-methylimidazolium bromide, 1-ethyl-3-methylimidazolium iodide, 1-ethyl-3-methylimidazolium nitrate, 1-butylpyridinium bromide, 1-butylpyridinium iodide, 1-butylpyridinium nitrate, 1-butyl-3-methylimidazolium hexafluorophosphate, 1-octyl-3-methylimidazolium hexafluorophosphate, 1-octyl-3-methylimidazolium tetrafluoroborate, 1-ethyl-3-methylimidazolium ethyl sulfate, 1-butyl-3-methylimidazolium acetate, 1-butyl-3-methylimidazolium trifluoroacetate, and 1-butyl-3-methyl imidazolium bis(trifluormethylsulfonyl)imide (Bmim-Tf₂N).

13. A cartridge for separating alcohol and/or other high octane compound from a feed mixture comprising gasoline and the alcohol and/or other high octane compound, the cartridge comprising a composite membrane according to claim 1.

14. A fuel separation system comprising one or more cartridges according to claim 13.

15. A method of separating a high octane compound from a mixture comprising the high octane compound and gasoline, the method comprising contacting the mixture with a composite membrane according to claim 1.
